(19) United States
(12) Patent Application Publication
(10) Pub. No.: US 2026/0184532 A1
(43) Pub. Date: Jul. 2, 2026

(54) BOOKBINDING PROCESSING APPARATUS, AND IMAGE FORMING SYSTEM INCLUDING BOOKBINDING PROCESSING APPARATUS

(71) Applicant: CANON FINETECH NISCA INC., Saitama (JP)

(72) Inventors: Daiki KOMIYAMA, Yamanashi (JP); Tadahito TAKANO, Yamanashi (JP); Keiichi NAGASAWA, Yamanashi (JP); Tatsuya SHIMIZU, Yamanashi (JP)

(21) Appl. No.: 19/551,881

(22) Filed: Feb. 27, 2026

Related U.S. Application Data
(63) Continuation of application No. PCT/JP2024/031318, filed on Aug. 30, 2024.

(30) Foreign Application Priority Data
Sep. 1, 2023 (JP) 2023-142449

(51) Int. Cl. B65H 37/06; B65H 29/20; B65H 29/58; B65H 29/66; B65H 31/24

(52) U.S. Cl. CPC B65H 37/06; B65H 29/20; B65H 29/58; B65H 29/6645; B65H 31/24

(57) ABSTRACT

A bookbinding processing apparatus includes: a conveyance control unit configured to control the conveyance unit to feed a preceding sheet conveyed through the conveyance path to the buffer path; and a buffer conveyance control unit configured to control the buffer conveyance unit to convey the preceding sheet from the buffer path to the conveyance path based on a detection result of a subsequent sheet following the preceding sheet by the detection unit. The conveyance control unit controls the conveyance unit to feed a bundle of the preceding sheet and the subsequent sheet to the bookbinding processing path.

### CROSS-REFERENCE TO RELATED APPLICATIONS

This application is a Continuation of International Patent Application No. PCT/JP2024/031318, filed Aug. 30, 2024, which claims the benefit of Japanese Patent Application No. 2023-142449, filed Sep. 1, 2023, both of which are hereby incorporated by reference herein in their entirety.

### BACKGROUND

### Field of the Technology

The present disclosure relates to a bookbinding processing apparatus that performs bookbinding processing for sheets with images formed thereon, and an image forming system including the bookbinding processing apparatus.

### Description of the Related Art

As an image forming system that performs post-processing for sheets, there is known a system including an image forming apparatus, and a post-processing apparatus that is connected to the discharge port of the image forming apparatus and stacks sheets with images formed thereon, performs post-processing, and loads the sheets on a loading portion.

As the post-processing, there is known bookbinding processing of performing binding processing at two points of the stacked sheets and folding the sheets in half to perform bookbinding.

PTL 1 describes a configuration that receives a sheet from a main body discharge port 3 of an image forming apparatus A and conveys it to a second stacking unit 35 via a second switchback conveyance path SP2 branched downward from a sheet loading path P1.

Also disclosed is a configuration that puts the trailing edge portion of a preceding sheet into a standby path P3 provided in the sheet loading path P1 during bookbinding processing in the second stacking unit 35, thereby inserting a subsequent sheet to the lower side of the preceding sheet.

However, PTL 1 has no technical concept that the position of the preceding sheet and the position of the subsequent sheet are aligned. This is because in the configuration of PTL 1, even if the subsequent sheet is to be moved forward, it is stopped by friction generated when it is sandwiched between the stopped preceding sheet and a roller 30a, and it is actually impossible to move the subsequent sheet from the state in FIG. 12C to the state in FIG. 12D.

### CITATION LIST

### Patent Literature

PTL 1: Japanese Patent Laid-Open No. 2008-213971

### SUMMARY

The present disclosure provides a bookbinding processing apparatus capable of aligning a sheet bundle and feeding it to a bookbinding processing path.

A bookbinding processing apparatus according to the present disclosure comprising: a conveyance path configured to convey a sheet from a loading port to an unloading port; a bookbinding processing unit configured to, provided on a lower side of the conveyance path, perform bookbinding processing including binding and folding for a sheet bundle; a bookbinding processing path configured to convey the sheet from the conveyance path to the bookbinding processing unit; a conveyance unit configured to, provided in the conveyance path, convey the sheet; a detection unit configured to detect that the sheet conveyed by the conveyance unit reaches a predetermined position; a buffer path provided on an upper side of the conveyance path and configured to buffer the sheet; a buffer conveyance unit configured to, provided in the buffer path, convey the sheet; a conveyance control unit configured to control the conveyance unit to feed a preceding sheet conveyed through the conveyance path to the buffer path; and a buffer conveyance control unit configured to control the buffer conveyance unit to convey the preceding sheet from the buffer path to the conveyance path based on a detection result of a subsequent sheet following the preceding sheet by the detection unit, wherein the conveyance control unit controls the conveyance unit to feed a bundle of the preceding sheet and the subsequent sheet to the bookbinding processing path.

Features of the present disclosure will become apparent from the following description of embodiments with reference to the attached drawings.

### BRIEF DESCRIPTION OF THE DRAWINGS

FIG. 1 is a view showing the outer appearance of an image forming system;

FIG. 2 is a view showing the configuration of a sheet post-processing apparatus;

FIG. 3 is a view showing a configuration near a straight path;

FIG. 4 is a view showing the configuration of a punch unit;

FIG. 5 is a view showing the configuration of a punch unit;

FIG. 6 is a view for explaining the shift mechanism of a conveyance roller;

FIG. 7 is a view for explaining the shift mechanism of a conveyance roller;

FIG. 8 is a view for explaining a binding processing mechanism;

FIG. 9 is a view for explaining a binding processing mechanism;

FIG. 10 is a view for explaining a binding processing mechanism;

FIG. 11 is a view for explaining an elevating mechanism for a tray;

FIG. 12A is a view for explaining a sheet unloading mechanism;

FIG. 12B is a view for explaining a sheet unloading mechanism;

FIG. 12C is a view for explaining a sheet unloading mechanism;

FIG. 13 is a view showing the configuration of a staple unit;

FIG. 14 is a view showing a configuration on the periphery of a control unit;

FIG. 15 is a flowchart showing processing of a bookbinding processing discharge mode;

FIG. 16A is a view for explaining a sheet buffer operation in a sheet processing apparatus;

FIG. 16B is a view for explaining the sheet buffer operation in the sheet processing apparatus;

FIG. 17A is a view for explaining the sheet buffer operation in the sheet processing apparatus;

FIG. 17B is a view for explaining the sheet buffer operation in the sheet processing apparatus;

FIG. 18A is a view for explaining the sheet buffer operation in the sheet processing apparatus;

FIG. 18B is a view for explaining the sheet buffer operation in the sheet processing apparatus;

FIG. 19A is a view for explaining the sheet buffer operation in the sheet processing apparatus;

FIG. 19B is a view for explaining the sheet buffer operation in the sheet processing apparatus;

FIG. 20A is a view for explaining the sheet buffer operation in the sheet processing apparatus;

FIG. 20B is a view for explaining the sheet buffer operation in the sheet processing apparatus;

FIG. 21A is a view for explaining the sheet buffer operation in the sheet processing apparatus;

FIG. 21B is a view for explaining the sheet buffer operation in the sheet processing apparatus;

FIG. 22A is a view for explaining the sheet buffer operation in the sheet processing apparatus;

FIG. 22B is a view for explaining the sheet buffer operation in the sheet processing apparatus;

FIG. 23 is a view for explaining the sheet buffer operation in the sheet processing apparatus;

FIG. 24A is a view for explaining lateral registration adjustment;

FIG. 24B is a view for explaining lateral registration adjustment;

FIG. 25A is a view for explaining lateral registration adjustment;

FIG. 25B is a view for explaining lateral registration adjustment;

FIG. 26A is a view for explaining lateral registration adjustment;

FIG. 26B is a view for explaining lateral registration adjustment;

FIG. 27A is a view for explaining lateral registration adjustment;

FIG. 27B is a view for explaining lateral registration adjustment;

FIG. 28A is a view for explaining lateral registration adjustment;

FIG. 28B is a view for explaining lateral registration adjustment;

FIG. 29A is a view for explaining lateral registration adjustment;

FIG. 29B is a view for explaining lateral registration adjustment;

FIG. 30A is a view for explaining lateral registration adjustment;

FIG. 30B is a view for explaining lateral registration adjustment;

FIG. 31A is a view for explaining lateral registration adjustment;

FIG. 31B is a view for explaining lateral registration adjustment;

FIG. 32A is a view for explaining lateral registration adjustment;

FIG. 32B is a view for explaining lateral registration adjustment;

FIG. 33A is a view for explaining lateral registration adjustment;

FIG. 33B is a view for explaining lateral registration adjustment;

FIG. 34A is a flowchart showing the sheet buffer operation;

FIG. 34B is a flowchart showing the sheet buffer operation;

FIG. 34C is a flowchart showing the sheet buffer operation;

FIG. 34D is a flowchart showing the sheet buffer operation;

FIG. 35A is a flowchart showing the sheet buffer operation;

FIG. 35B is a flowchart showing the sheet buffer operation;

FIG. 35C is a flowchart showing the sheet buffer operation;

FIG. 35D is a flowchart showing the sheet buffer operation;

FIG. 36A is a view for explaining an operation in a case of a large-size sheet;

FIG. 36B is a view for explaining an operation in a case of a large-size sheet;

FIG. 37 is a view for explaining an operation in a case of a large-size sheet

FIG. 38A is a view for explaining an operation in a case of a large-size sheet;

FIG. 38B is a view for explaining an operation in a case of a large-size sheet; FIG. 39A is a view for explaining an operation in a case of a large-size sheet;

FIG. 39B is a view for explaining an operation in a case of a large-size sheet;

FIG. 40 is a view for explaining another embodiment; and

FIG. 41 is a view for explaining another embodiment.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made to the disclosure that requires all such features, and multiple such features may be combined as appropriate. Furthermore, in the attached drawings, the same reference numerals are given to the same or similar configurations, and redundant description thereof is omitted.

### Image Forming Apparatus

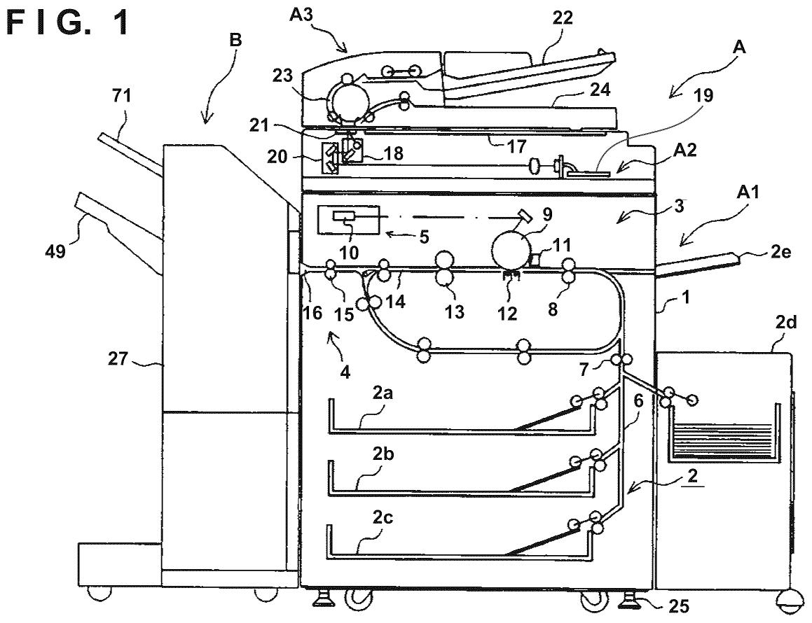

An image forming apparatus A in an image forming system shown in FIG. 1 will be described. The image forming apparatus A shown in FIG. 1 indicates an electrostatic printing mechanism and is configured to include an image forming unit A1, a scanner unit A2, and a feeder unit A3. On an apparatus housing 1, installation legs 25 installed on an installation surface (for example, a floor surface) are provided. Also, a feeding unit 2, an image forming unit 3, a discharge unit 4, and a data processing unit 5 are incorporated in the apparatus housing 1.

The feeding unit 2 is configured to include cassette mechanisms 2a to 2c that store sheets of a plurality of sizes to form images, and feeds a sheet of a size designated by a main body control unit 90 to a feeding path 6. Hence, the plurality of cassettes 2a to 2c are detachably arranged in the apparatus housing 1, and each cassette incorporates a separation mechanism that separates the sheets inside one by one, and a feeding mechanism that feeds the sheets. In the feeding path 6, conveyance rollers 7 that feed sheets supplied from the plurality of cassettes 2a to 2c to the downstream side are provided, and a registration roller pair 8 that aligns the leading edge of each sheet is provided at the path end portion.

Note that a large-capacity cassette 2d and a manual tray 2e are connected to the feeding path 6. The large-capacity cassette 2d is configured to include an optional unit that stores sheets of a size to be consumed in large quantities. The manual tray 2e is configured to supply a special sheet difficult to separately feed, such as a thick sheet, a coating sheet, or a film sheet.

The image forming unit 3 is shown as an example of an electrostatic printing mechanism, and a photosensitive member 9 (a drum or a belt) is provided, and a light emitting device 10 that emits an optical beam to the photosensitive member 9, a developing device 11 (developer), and a cleaner (not shown) are arranged around the rotating photosensitive member. The illustrated mechanism indicates a monochrome printing mechanism, in which a latent image is optically formed on the photosensitive member 9 by the light emitting device 10, and the developing device 11 adheres toner ink to the latent image. In accordance with a timing of forming an image on the photosensitive member 9, a sheet is fed from the feeding path 6 to the image forming unit 3, and the image is transferred to the sheet by a transfer charger 12 and fixed by a fixing unit (roller) 13 arranged in a discharge path 14. In the discharge path 14, discharge rollers 15 and a discharge port 16 are arranged, and the sheet is conveyed to a sheet post-processing apparatus B to be described later.

The scanner unit A2 is configured to include a platen 17 on which an image original is placed, a carriage 18 that reciprocally moves along the platen 17, a light source mounted on the carriage 18, and a reduction optical system 20 (a combination of mirrors and lenses) that guides reflected light from the original on the platen 17 to a photoelectric conversion unit 19. Reference numeral 21 in FIG. 1 denotes a second platen (traveling platen) that performs image reading, by the carriage 18 and the reduction optical system 20, for a sheet fed from the feeder unit A3. The photoelectric conversion unit 19 transfers photoelectrically converted image data to the image forming unit 3.

The feeder unit A3 is configured to include a feeding tray 22, a feeding path 23 that guides a sheet fed from the feeding tray to the traveling platen 21, and a discharge tray 24 that stores the original that has undergone image reading by the platen.

The image forming apparatus A is not limited to the above-described mechanism, and a printing mechanism such as an offset printing mechanism, an inkjet printing mechanism, or an ink ribbon transfer printing mechanism (thermal transfer ribbon printing, sublimation ribbon printing, or the like) can be employed.

### Sheet Post-Processing Apparatus

As an apparatus that post-processes a sheet discharged from the discharge port 16 of the image forming apparatus A, the sheet post-processing apparatus B has, for example, (1) a function of loading and storing sheets with images formed thereon (printout mode), (2) a function of sorting and storing sheets with images formed thereon (jog sorting mode), (3) a function of aligning, stacking, and binding sheets with images formed thereon (binding processing mode), and (4) a function of aligning and binding sheets with images formed thereon and then folding the sheets to perform bookbinding finishing (bookbinding processing mode).

Note that in this embodiment, the sheet post-processing apparatus B need not have all the functions described above and is configured appropriately in accordance with apparatus specifications (design specifications). In this embodiment, as an example, the sheet post-processing apparatus B is assumed to have the function of aligning and binding sheets with images formed thereon and then folding the sheets to perform bookbinding finishing.

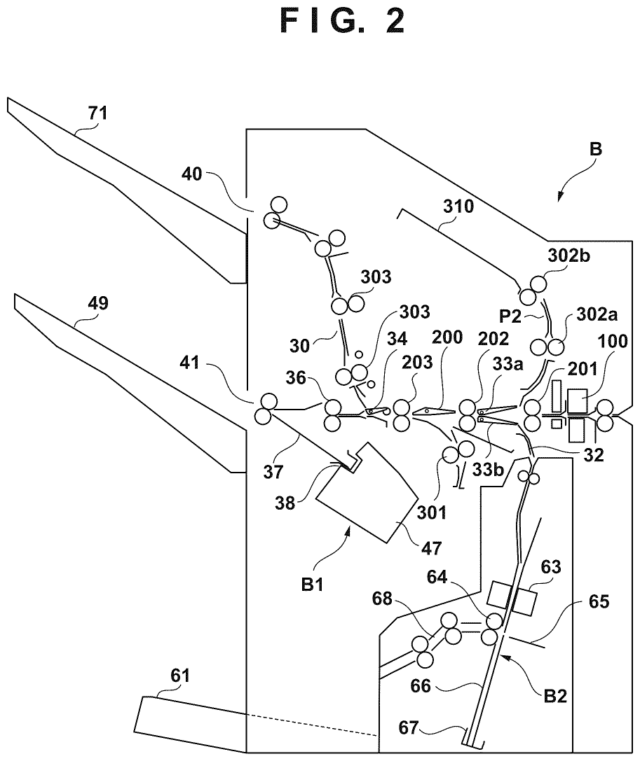

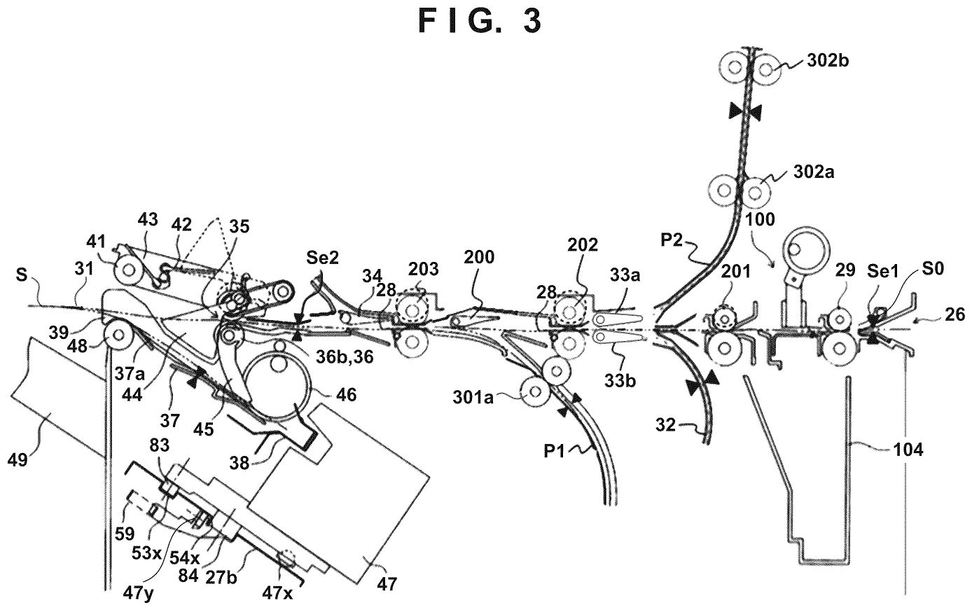

FIG. 2 shows the configuration of the sheet post-processing apparatus B, and FIG. 3 shows a configuration near a straight path 28. The sheet post-processing apparatus B post-processes a sheet loaded from a straight path inlet 26 connected to the discharge port 16 of the image forming apparatus A and then stores it in a storage unit (a first stack tray 49, a second stack tray 61, and a third stack tray 71 to be described later). The apparatus shown in FIG. 2 transfers the sheet sent to the straight path 28 from a processing unit B1 including a binding unit 47 to the first stack tray 49 (to be referred to as the “first tray” hereinafter) and the third stack tray 71 (to be referred to as the “third tray” hereinafter). The apparatus shown also transfers the sheet sent to the straight path 28 from a saddle unit B2 to the second stack tray 61 (to be referred to as the “second tray” hereinafter). Note that the straight path 28 is formed into a substantially linear shape and can therefore convey even a thick sheet.

The processing unit B1 is arranged at the path outlet (straight path discharge port 35) of the straight path 28, and aligns, stacks, and binds sequentially sent sheets and then stores these in the first tray 49. The saddle unit B2 is a post-processing unit that is arranged at the path outlet (saddle path discharge port) of a saddle path 32 branched from the straight path 28 and aligns, stacks, and saddle-stitches (sometimes does not saddle-stitch) sequentially sent sheets, then folds the sheets, and stores these in the second tray 61. The components will be described below in detail.

### Apparatus Housing

As shown in FIG. 2, the sheet post-processing apparatus B includes an apparatus housing 27, the straight path 28 incorporated in the apparatus housing and including the straight path inlet 26 and the straight path discharge port 35, the processing unit B1 and the saddle unit B2, which post-process a sheet sent from the straight path 28, and the first tray 49, the second tray 61, and the third tray 71, which store a sheet sent from each post-processing unit. The apparatus housing 27 shown in FIG. 2 is arranged at substantially the same height as the housing 1 of the image forming apparatus A located on the upstream side, and on the installation surface, the discharge port 16 of the image forming apparatus A and the straight path inlet 26 of the sheet post-processing apparatus B are connected.

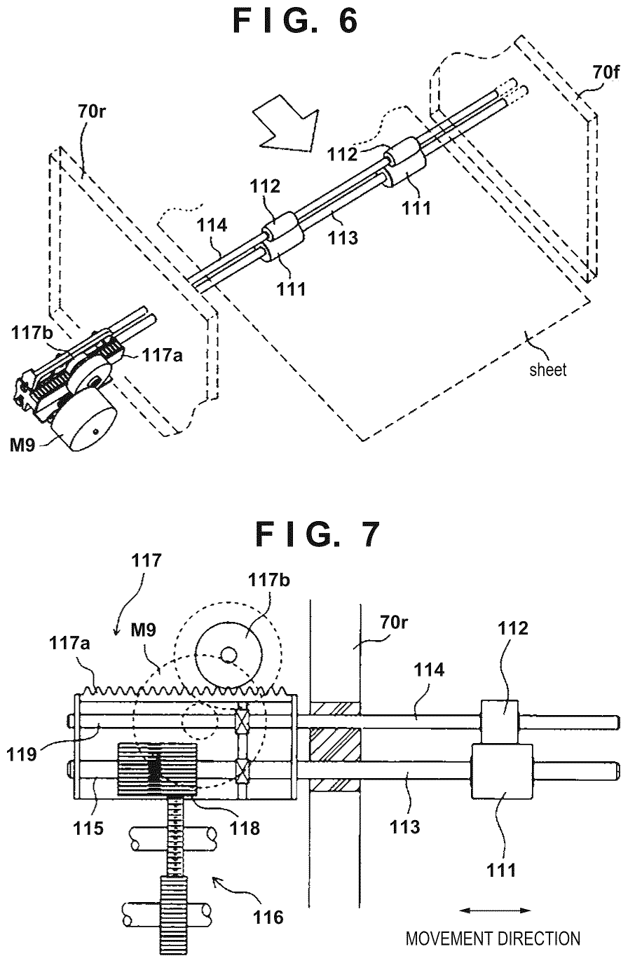

The housing 27 of the sheet post-processing apparatus is configured to include an apparatus frame 70. The apparatus frame 70 forms, for example, a box-shaped apparatus framework as shown in FIG. 6, and is configured to include a front-side side frame 70f located in front in the state shown in FIG. 1, a rear-side side frame 70r located on the rear surface, and a stay member (connection reinforcing member) that connects the two side frames. The straight path 28, the processing unit B1, the saddle unit B2, and the like to be described later are attached between the left and right side frames. The apparatus housing 27 is not limited to the illustrated shape, and can have a form preferable for the design, as a matter of course. The apparatus frame 70 need not always have the left and right side frames and the connecting stay structure, and various frame structures such as a monocoque structure can be employed.

### Sheet Loading Path

As shown in FIG. 3, the straight path 28 is formed by a substantially linear path that crosses the apparatus housing 27 in a substantially horizontal direction, and includes the straight path inlet 26 connected to the discharge port (main body discharge port) 16 of the image forming apparatus A, and the straight path discharge port 35 that is located on the opposite side of the straight path inlet 26, crossing the apparatus from the loading port (straight path inlet 26). In the straight path 28, inlet rollers 29, first conveyance rollers 201, second conveyance rollers 202, and third conveyance rollers 203 are arranged sequentially from the side of the straight path inlet 26 as a conveyance mechanism that can convey a sheet from the straight path inlet 26 to the straight path discharge port 35 and can also convey a sheet from the straight path discharge port 35 to the straight path inlet 26. Also, discharge rollers 36 (including a sheet conveyance mechanism such as a belt) are arranged as a conveyance mechanism in the straight path discharge port 35. Near the straight path inlet 26, an inlet sensor Se1 that detects one or both of the leading and trailing edges of a sheet to be accepted and a lateral registration detection sensor S0 (detection unit) that detects an end face position (side end) parallel to the sheet conveyance direction are arranged. Also, near the straight path discharge port 35, a discharge sensor Se2 that detects the leading and trailing edges of a sheet is arranged. The sheet discharged from the straight path discharge port 35 is discharged to the first tray 49 via a first discharge path 31 connected to the straight path discharge port 35 or guided to the processing unit B1. In the straight path 28, a punch unit 100 that punches punch holes in a sheet is arranged. As the inlet sensor Se1 and the discharge sensor Se2, a photo interrupter or a combination of a sensor and a flag that comes into contact with a sheet can be employed.

### Layout of Sheet Loading Path

In the straight path 28, as shown in FIGS. 2 and 3, “the saddle path 32”, “a saddle buffer path P2”, “a processing unit buffer path P1”, and “an upper conveyance path 30” are arranged in this order from the straight path inlet 26 to the straight path discharge port 35. At branch portions to the paths, a saddle path flapper 33b, a saddle buffer path flapper 33a, a processing unit buffer path flapper 200, and an upper conveyance path flapper 34 are arranged as conveyance switching mechanisms (branching mechanisms) for a conveyed sheet. In this embodiment, the saddle buffer path P2 and the upper conveyance path 30 are each formed as a retreat path for retreating a sheet. Also, as shown in FIG. 2, the saddle unit B2 is provided on one side across the straight path 28, and the saddle buffer path P2 and the upper conveyance path 30 are provided on the opposite side (other side). This can further improve the conveyance efficiency of a sheet located in the retreat path to the saddle unit B2.

In the above-described paths, the saddle path 32, the saddle buffer path P2, and the processing unit buffer path P1 are each formed as a switchback path that conveys a sheet in a direction reverse to the conveyance direction from the straight path inlet 26 to the straight path discharge port 35 and loads the sheet to each path. Also, the upper conveyance path 30 is configured to convey a sheet in the same direction as the conveyance direction from the straight path inlet 26 to the straight path discharge port 35, thereby loading the sheet.

### Path Branching Mechanism

The saddle path flapper 33b, the saddle buffer path flapper 33a, and the processing unit buffer path flapper 200, which are the sheet branching mechanisms, are each formed by a flapper guide capable of moving to switch the conveyance path of a sheet loaded from the straight path inlet 26, and connected to a driving mechanism (not shown) such as an electromagnetic solenoid or a mini motor. The saddle path flapper 33b guides a sheet sent from the straight path inlet 26 to the saddle path 32. The saddle buffer path flapper 33a guides a sheet sent from the straight path inlet 26 to the saddle buffer path P2. The processing unit buffer path flapper 200 guides a sheet sent from the straight path inlet 26 to the processing unit buffer path P1 via processing unit buffer rollers 301a and 301b. The upper conveyance path flapper 34 is configured to include a flapper guide capable of moving to switch the conveyance path to convey a sheet sent from the straight path inlet 26 to one of the straight path discharge port 35 and the upper conveyance path 30, and connected to a driving mechanism (not shown) such as an electromagnetic solenoid or a mini motor.

### Upper Conveyance Path

The upper conveyance path 30 (printout discharge path) that loads sheets other than those to be discharged to the straight path discharge port 35 is connected to the straight path 28, and the path branching portion is provided with the upper conveyance path flapper 34 configured to guide a sheet to the upper conveyance path 30. Also, the upper conveyance path 30 includes upper conveyance rollers 303 (303a and 303b) that guide a sheet to the third tray 71. The sheet guided by these to the upper conveyance path 30 is discharged from an upper conveyance path discharge port 40 to the third tray 71 (overflow tray). Note that in this embodiment, the upper conveyance path 30 is also used as a sheet retreat path.

### Saddle Path

The saddle path 32 configured to load a sheet to the saddle unit B2 is connected to the straight path 28, and the path branching portion is provided with the saddle path flapper 33b configured to guide the sheet to the saddle path 32. The sheet guided from the saddle path 32 to the saddle unit B2 via the saddle path discharge port undergoes saddle-stitching processing and folding processing and is then discharged to the second tray 61 via a saddle discharge path 68 in a substantially horizontal direction. Note that the saddle unit B2 is preferably arranged on the lower side of the straight path 28 because it aligns sheets using gravity as well.

### Saddle Buffer Path

The saddle buffer path P2 configured to temporarily load a sheet that should undergo saddle-stitching processing and folding processing in the saddle unit B2 and make the sheet stand by is connected to the straight path 28, and the saddle buffer path flapper 33a configured to guide a sheet to the saddle buffer path P2 is formed. Also, the saddle buffer path P2 includes conveyance rollers 302 (302a and 302b) that load a sheet and make it temporarily stand by.

A fourth tray discharge port 305 is provided on the extension on the downstream side of the saddle buffer path P2 and, therefore, a sheet loaded into the saddle buffer path P2 can be discharged onto a fourth tray 310 and loaded on it. In this case, the fourth tray 310 is arranged vertically above the saddle buffer path P2. Note that the fourth tray 310 may be shared with an exterior component of the top surface of the sheet post-processing apparatus B, or may be fixed to apparatus housing. The fourth tray 310 may be configured to include a driving mechanism and be movable up/down in a substantially vertical direction.

Note that when the saddle buffer path P2 is arranged at a position to overlap vertically above the punch unit 100, the apparatus can be made more compact. However, if a space is needed to spring the punch unit 100 up to remove a sheet staying in the punch unit 100, the saddle buffer path P2 may be arranged at a position not to overlap vertically above the punch unit 100.

### Conveyance Roller Shift Mechanism in Loading Path

A conveyance shift mechanism of conveyance rollers on the conveyance path will be described here with reference to FIGS. 6 and 7. The first conveyance rollers 201, the second conveyance rollers 202, the third conveyance rollers 203, and the conveyance rollers 302a and 302b are configured to include driving rollers 111 and driven rollers 112, which are supported, via bearings, by the left and right side frames 70f and 70r. A driving rotation shaft is connected to a driving roller shaft 113 via a transmission mechanism 116 (a gear transmission type is shown), and a driving motor (not shown) common to the discharge roller 36 is connected to a driving rotation shaft 115. A driven roller shaft 114 is movably supported, via bearings, by the left and right side frames 70f and 70r.

Each conveyance roller described above is rotatably attached to a shift member 117 that connects the driving roller shaft 113 and the driven roller shaft 114. By the shift member 117, the driving roller shaft 113 and the driven roller shaft 114 are connected to integrally move in the axial direction (thrust direction), and can independently rotate in the radial direction. The driving roller shaft 113 is supported, via bearings, by the left and right side frames 70f and 70r, an end portion of the driving roller shaft 113 is located in a range indicated by the axial-direction moving region of the conveyance roller on the front side of the side frame 70f, and the other end portion is located on the rear side of the side frame 70r. The shift member 117 (for example, a block member of a synthetic resin) is supported by the driving roller shaft 113 and the driven roller shaft 114 and integrally connects the two roller shafts.

A rack 117a is integrally formed on the shift member 117 and meshed with a shift motor M9 attached to the side frame 70r (the apparatus housing: the same applies hereafter) and a transmission pinion 117b. In this configuration, the shift member 117 can be moved (shift-moved) in the axial direction of the conveyance roller by the rotation of the shift motor M9 (a stepping motor capable of rotating in forward and reverse directions is shown).

A passive gear 118 is integrally formed on the driving rotation shaft 115, and the rotation of the driving motor is transmitted to the passive gear 118. In addition, a conveyance roller pair (a driving roller and a driven roller) is in pressure contact with a driven rotation shaft 119 such that it is driven and rotated by the rotation of the driving rotation shaft 115.

In this embodiment, the driving rotation shaft 115 and the driven rotation shaft 119 are connected to each other and configured such that when one of the rotation shafts moves in the axial direction, the other is driven. In addition, one of the driving roller 111 and the driven roller 112 may be attached to a rotation shaft such that it can slidably move (slide) in the axial direction, and the other roller may be moved in the axial direction such that it is linked with the movement.

### Conveyance Shift Operation

A shift operation (jog sorting mode) of a sheet loaded into the sheet post-processing apparatus B will be described here. A sheet sent from the image forming apparatus A is conveyed to the straight path inlet 26, the inlet rollers 29, the first conveyance rollers 201, the second conveyance rollers 202, and the third conveyance rollers 203 in this order. At this time, the transfer timing of the sheet is simultaneously detected by the inlet sensor Se1. While the sheet loaded by the inlet rollers 29 passes through the straight path 28, an end position of the sheet is detected by the lateral registration detection sensor S0. The lateral registration detection sensor S0 detects how much a lateral registration error X of the sheet has occurred with respect to the center position.

If the lateral registration error X is detected by the lateral registration detection sensor S0, the rollers of the first conveyance rollers 201, the second conveyance rollers 202, and the third conveyance rollers 203 move by predetermined amounts to front and rear sides while sequentially conveying the sheet, thereby performing the shift operation of the sheet (to be also referred to as “lateral registration detection processing”). After that, the sheet is distributed and conveyed to the straight path discharge port 35 or the upper conveyance path 30 by the upper conveyance path flapper 34 that is a branching mechanism, and discharged onto the first tray 49 or the third tray 71.

### Processing Unit

The processing unit B1 is a post-processing unit configured to include a processing tray 37 that is arranged on the downstream side of the straight path 28 and aligns and stacks a sheet sent from the straight path discharge port 35, and a binding processing mechanism that binds a stacked sheet bundle. As shown in FIG. 3, in the straight path discharge port 35 of the straight path 28, a step is formed, and the processing tray 37 is arranged under it. A first discharge path (first switchback path) 31 that reverses the conveyance direction from the discharge port and guides the sheet onto the tray is formed between the straight path discharge port 35 and the processing tray 37.

A sheet loading mechanism that loads the sheet from the discharge port onto the tray is arranged between the straight path discharge port 35 and the processing tray 37. In the processing tray 37, a positioning mechanism that positions a sheet at a predetermined binding position and a sheet bundle unloading mechanism that discharges the bound sheet bundle to the first tray 49 on the downstream side are arranged. The components will be described later.

Note that the processing tray 37 shown in FIG. 3 bridge-supports, between it and the first tray 49 on the downstream side, the sheet sent from the straight path discharge port 35. That is, the processing tray 37 is configured such that the sheet sent from the straight path discharge port 35 is bridge-supported with its leading edge portion located on the uppermost sheet on the first tray 49 on the downstream side and its trailing edge portion located on the processing tray 37.

### Saddle Unit

The saddle unit B2 is a post-processing unit that aligns and stacks sheets sent from the straight path 28, binds the sheets at the center portion, and fold these inward (to be referred to as “magazine finishing” hereinafter). The second tray 61 is arranged on the downstream side of the saddle unit B2 to store the sheet bundle that has undergone bookbinding processing. Note that the saddle unit may be configured to align and stack one or a plurality of sheets and only fold these inward at the center portion without performing saddle-stitching processing.

The saddle unit B2 is configured to include a guide member 66 that stacks sheets in a bundle, a leading edge regulating stopper 67 that positions a sheet at a predetermined position on the guide member 66, a staple device 63 (saddle-stitching staple unit) that saddle-stitches, at the center portion, the sheets positioned by the leading edge regulating stopper 67, and a folding processing mechanism (a folding roll pair 64 and a folding blade 65) that folds the sheet bundle at the center portion after the binding processing.

As the saddle-stitching staple unit 63, a generally known mechanism that moves, along a sheet center portion (line), a sheet bundle sandwiched between a head unit and an anvil unit and performs binding processing is employed. The folding processing mechanism is configured such that, as shown in FIG. 2, the crease of the sheet bundle is inserted, by the folding blade 65, between the rolls of the folding roll pair 64, which are in pressure contact with each other, and the sheet bundle is folded by rolling of the roll pair.

The processing unit B1 and the straight path 28 shown in FIG. 2 are arranged in a substantially horizontal direction, the saddle path 32 that guides a sheet to the saddle unit B2 is arranged in the vertical direction, and the guide member 66 that aligns and stacks a sheet is arranged in a substantially vertical direction. When the straight path 28 is arranged in a direction of crossing the apparatus housing 27, and the saddle path 32 and the saddle unit B2 are arranged in the vertical direction, the apparatus can be made slim. Note that the saddle unit B2 according to this embodiment indicates a tray that supports a sheet, a binding unit, and a folding unit, and is arranged such that the lower end portion is located on the downstream side in the conveyance direction (the left side in FIG. 2) with respect to the upper end portion when the guide member 66 supports a maximum size sheet, thereby implementing size reduction in the conveyance direction.

The second tray 61 is arranged on the downstream side of the saddle unit B2, and a sheet bundle folded like a magazine can be stored. The second tray 61 is arranged on the lower side of the first tray 49. This is because the use frequency of the first tray 49 is assumed to be higher than the use frequency of the second tray 61, and the position of the first tray 49 is set as a height to easily extract a sheet on the tray.

### Punch Unit

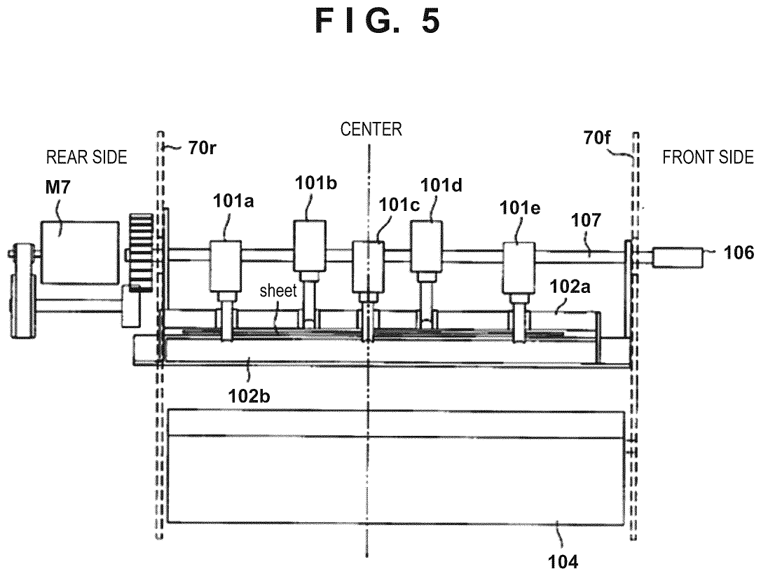

The punch unit 100 that is arranged in the straight path 28 and punches punch holes in a sheet sent from the straight path inlet 26 will be described with reference to FIG. 5. In the punch unit 100, a plurality of punch members 101a to 101e are arrayed at a predetermined interval in a direction orthogonal to the sheet conveyance direction of the straight path 28, and a selected number of holes are punched in a sheet.

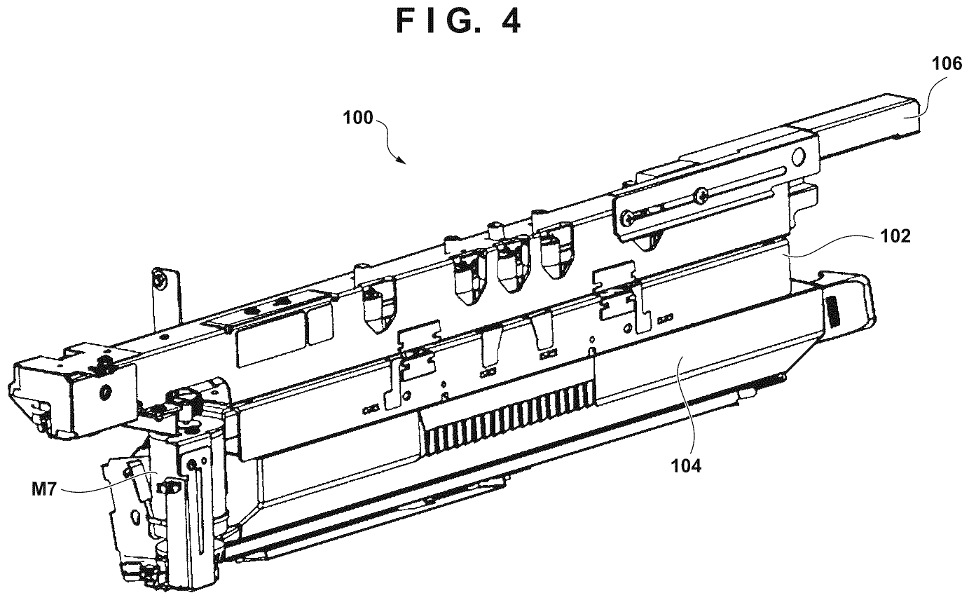

FIG. 4 shows the overall configuration of the punch unit 100. The punch unit 100 is configured to include a unit frame 102, the plurality of punch members 101a to 101e arrayed in the unit frame 102 to be movable in the vertical direction, a drive cam that moves each punch member in the vertical direction (reciprocally moves each punch member in the punch direction), and a driving motor M7 that drives the drive cam.

Reference numeral 104 in FIG. 4 denotes a waste box that is arranged under punch members 101 and stores punching chips. The waste box 104 is attached to a guide rail (not shown) such that it can slide with respect to the apparatus frame 70 (different from the unit frame). Reference numeral 106 denotes a rotation operation member that forcibly rotates the drive cam to separate (disengage) the punch member 101 embedded in a sheet in a case of jam in the punch member 101 or an abnormality in the driving motor M7. Hence, the rotation operation member 106 is formed by a manual rotary knob connected to a rotation shaft 107 of the drive cam.

As shown in FIG. 5, the unit frame 102 is configured to include an upper frame 102a and a lower frame 102b, each of which has a predetermined length in a direction orthogonal to the sheet conveyance direction of the straight path 28. In the upper frame 102a, the plurality of punch members 101a to 101e are arranged at a predetermined interval in a direction (to be referred to as a “conveyance orthogonal direction” hereinafter) orthogonal to the sheet conveyance direction such that these can reciprocally move (vertically move) in a punching direction. In the lower frame 102b, punching holes (dies) are formed at positions facing the punch member 101. In addition, the driving rotation shaft 107 is arranged in the unit frame 102, and the drive cam that moves the punch members 101 in the vertical direction is attached to the driving rotation shaft 107. The driving motor M7 is connected to the driving rotation shaft 107 via a transmission mechanism.

The drive cam is formed by a cylindrical cam member pivotally attached to the driving rotation shaft 107 and corresponding to the plurality of punch members 101, and each punch member is connected to the cam member via a connecting pin. When the driving rotation shaft 107 rotates by a predetermined angle, the punch members 101 vertically move in the punching direction. At this time, the punch members 101b and 101d of a first group (for example, two-hole punching) in the plurality of punch members vertically move in the punching direction at a first rotation angle of the driving rotation shaft 107. At a different second rotation angle, the punch members 101a, 101c, and 101e of a second group (for example, three-hole punching) vertically move in the punching direction.

Hence, when the driving rotation shaft 107 is reciprocally rotated within a preset angle range under the control of the motor M7, a binding processing control unit 95 to be described later causes the punch members 101b and 101d of the first group to make a punching motion. When the driving rotation shaft 107 is reciprocally moved within a different angle range, the punch members 101a, 101c, and 101e of the second group can be caused to make a punching motion.

The waste box 104 is arranged under the punch members 101 and supported by a guide rail (not shown) provided in the apparatus frame, and can be detached from the apparatus front side.

The driving motor M7 is connected to the driving rotation shaft 107 via a deceleration mechanism (gear transmission mechanism). To allow an operator to manually make rotation, a rotation member is inserted to a hole provided in the side frame 70f and arranged on the front side of the side frame 70f. A front cover is openably and closably arranged on the apparatus front side, and in an open state, the rotation operation member 106 can be operated. Note that in the cover open state, the driving power to the driving motor M7 is not supplied (blocked).

### Configuration of Processing Unit

The configurations of the sheet loading mechanism, the sheet positioning mechanism, the binding processing mechanism, and the sheet bundle unloading mechanism of the processing unit B1 will be described next.

### Sheet Loading Mechanism

As shown in FIG. 3, a reversing conveyance mechanism that switchback-conveys a sheet from the straight path discharge port 35 in a discharge direction and a discharge opposing direction, a guide mechanism (sheet guide member) 44 that guides the sheet to the tray side, and a raking rotation body 46 that guides the sheet to a trailing edge regulating portion are arranged between the straight path discharge port 35 and the processing tray 37.

The reversing conveyance mechanism is configured to include an elevating roller 41 that vertically moves between an operating position at which it engages with a sheet loaded onto the processing tray 37 and a standby position at which it is apart from the sheet, and a paddle rotation body 42 that transfers the sheet to the discharge opposing direction, and the elevating roller 41 and the paddle rotation body 42 are attached to a swing bracket 43.

In the apparatus housing 27, the swing bracket 43 is arranged to be able to swing about a rotation shaft (for example, a discharge roller shaft). The rotation shafts of the elevating roller 41 and the paddle rotation body 42 are supported by the swing bracket 43 via bearings. An elevating motor (not shown) is connected to the swing bracket 43, and the swing bracket 43 vertically moves the elevating roller 41 and the paddle rotation body 42, which are mounted thereon, between the operating position at which the elevating roller 41 engages with a sheet and the standby position at which it is apart from the sheet.

Also, a driving motor (not shown) is connected to the elevating roller 41 and the paddle rotation body 42 to transmit driving such that the elevating roller 41 rotates in forward and reverse directions, and the paddle rotation body 42 rotates in the reversing direction (discharge opposing direction). A driven roller 48 that is in pressure contact with the elevating roller 41 is arranged in the processing tray 37 to nip a single sheet or a bundle of sheets and discharge it to the downstream side.

A guide mechanism that guides the trailing edge of a sheet loaded onto the processing tray 37 toward a sheet end regulating portion 38 is arranged between the elevating roller 41 and the raking rotation body 46 to be described later. The guide mechanism is configured to include the sheet guide member 44 that vertically moves from a dotted line state to a solid line state in FIG. 3. The sheet guide member 44 retreats to the dotted line position when a sheet is discharged from the straight path discharge port 35, and after the sheet trailing edge passes through the straight path discharge port 35, guides the sheet trailing edge onto the processing tray 37. To do this, a driving mechanism (not shown) is connected to the sheet guide member 44, and the sheet guide member 44 vertically moves in accordance with the timing of guiding the sheet trailing edge from the straight path discharge port 35 onto the processing tray 37.

### Sheet Positioning Mechanism

Positioning mechanisms 38 and 39 that position a sheet at a predetermined binding position are arranged on the processing tray 37, and those shown in FIG. 3 are configured to include the sheet end regulating portion 38 that regulates a sheet trailing edge by abutment, and the side edge alignment portion 39 that positions a sheet side edge to a reference position (center reference or one side reference).

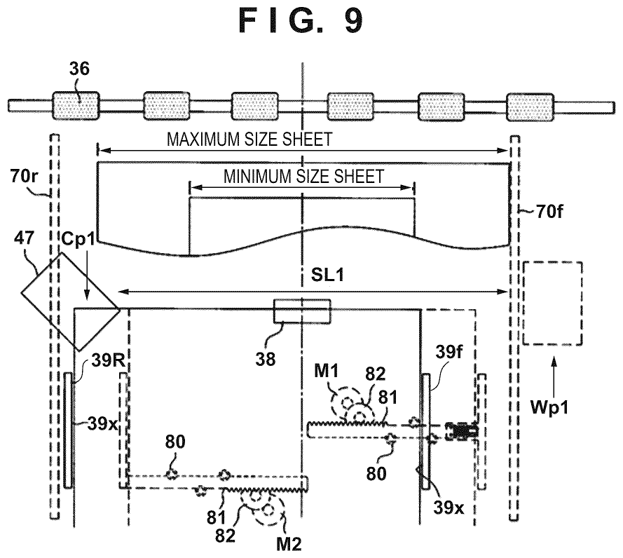

As shown in FIG. 3, the sheet end regulating portion 38 is formed by a stopper member that regulates a sheet trailing edge by abutment. As for the side edge alignment portion 39, as will be described later with reference to FIG. 9, a sheet is discharged from the straight path 28 with the center reference, and positioning with the same center reference or positioning with the one side reference is executed in accordance with the type of the binding mode.

### Side Edge Alignment Mechanism

As shown in FIG. 9, side edge alignment plates 39F and 39R project upward from a sheet placement surface 37a of the processing tray 37, have regulating surfaces 39x that engage with the side edges of a sheet, and are arranged as a pair of left and right parts facing each other. The pair of side edge alignment portions 39 is arranged on the processing tray 37 such that these can reciprocally move at a predetermined stroke. The stroke is set based on the size difference between a maximum size sheet and a minimum size sheet and an offset amount to move (offset-convey) a sheet bundle after alignment in one of left and right directions.

That is, the moving stroke of the left and right side edge alignment plates 39F and 39R is set based on the moving amount to align a different size sheet and the offset amount of a sheet bundle after alignment. Note that in corner binding, the side edge alignment plates 39F and 39R move a sheet unloaded with the center reference, by a predetermined amount, to the right side in a case of right corner binding or to the left side in a case of left corner binding (offset movement). The offset movement is executed every time a sheet is loaded to the processing tray 37 (for each loaded sheet), or executed to move a bundle to perform binding processing after sheets are aligned into the bundle.

Hence, as shown in FIG. 9, the side edge alignment portions 39 are configured to include the right side edge alignment plate 39F (apparatus front side) and the left side edge alignment plate 39R (apparatus rear side). For the two side edge alignment members, the regulating surfaces 39x that engage with sheet side ends are supported on the processing tray 37 such that these move in approaching directions or separating directions. Slit grooves (not shown) extending through the processing tray from the upper surface to the lower surface are provided in the processing tray 37. The side edge alignment portions 39 with the regulating surfaces 39x that engage with sheet side edges are slidably fitted in the slit grooves.

The side edge alignment plates 39F and 39R are slidably supported by a plurality of guide rolls 80 on the tray rear surface, and racks 81 are integrally formed. Alignment motors M1 and M2 are connected to the left and right racks 81 via pinions 82. The left and right alignment motors M1 and M2 are each formed by a stepping motor, and are configured to detect the positions of the left and right side edge alignment plates 39F and 39R by position sensors (not shown) and, based on detection values, move the alignment members in both left and right directions by a designated moving amount. Note that the configuration is not limited to the rack-and-pinion mechanism shown in FIG. 9, and the side edge alignment plates 39F and 39R may be fixed to a timing belt, and the timing belt may be connected, by a pulley, to a motor that reciprocally moves the timing belt in the left and right directions.

In the above-described configuration, the binding processing control unit 95 to be described later makes the left and right side edge alignment plates 39F and 39R stand by at predetermined standby positions (width size of sheet+α position) based on sheet size information provided from the image forming apparatus A. In “multi-binding”, a sheet is loaded onto the processing tray 37, and an alignment operation is started at a timing when a sheet end abuts against the sheet end regulating portion 38. The alignment operation is performed by rotating the left and right alignment motors M1 and M2 by the same amount in opposite directions (approaching directions). Then, the sheet loaded onto the processing tray 37 is positioned based on the sheet center as the reference, and stacked into a bundle. The sheet loading operation and the alignment operation are repeated, thereby aligning and stacking sheets in a bundle on the processing tray 37. At this time, sheets of different sizes are positioned with the center reference. In “corner binding”, a sheet is loaded onto the processing tray 37, and an alignment operation is started at a timing when a sheet end abuts against the sheet end regulating portion 38. The alignment operation is performed by setting different moving amounts for the alignment plate on the binding position side and the alignment plate on the opposite side of the binding position. The moving amounts are set such that a sheet corner is located at a preset binding position.

### Binding Processing Mechanism

On the processing tray 37, a binding processing mechanism 47 that binds a sheet bundle stacked on the sheet placement surface 37a is arranged. The sheet placement surface 37a of the processing tray 37 is positioned to a predetermined binding position by a positioning mechanism (the sheet end regulating portion 38 and the side edge alignment portion 39). The binding processing mechanism 47 is formed as the binding unit 47 (“staple unit”: the same applies hereafter) that needle-binds a sheet bundle using staple needles.

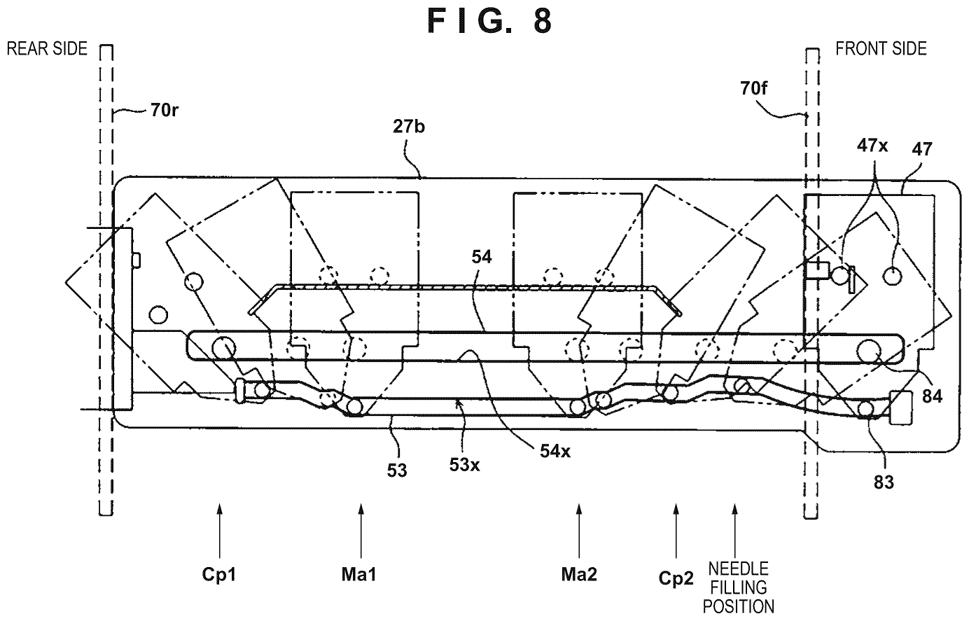

On the processing tray 37, the binding processing mechanism 47 that binds the trailing edge of a sheet loaded from the straight path discharge port 35 is arranged. As shown in FIG. 8, the binding processing mechanism 47 is formed by the staple unit 47 capable of moving along the rear end portion of the sheet placement surface 37a of the processing tray 37.

FIGS. 8 and 9 show the staple unit 47 arranged on the processing tray 37. In FIG. 9, a binding position Cp1 is set at a sheet corner located on the left side. The staple unit 47 moves at a predetermined stroke SL1 along a first traveling rail 53 and a second traveling rail 54 formed on an apparatus frame 27b.

FIG. 9 shows the sheet loaded onto the processing tray 37 and the moving stroke SL1 of the binding unit 47. To the processing tray 37, sheets of different sizes including a maximum size sheet to a minimum size sheet are loaded with the center reference. The sheets are aligned by the pair of left and right side edge alignment plates 39F and 39R with respect to the binding side edge (the left side edge in FIG. 9) of the sheets as the reference such that the sheets of different sizes match. To do this, the left and right side edge alignment plates 39F and 39R are connected to the different driving motors M1 and M2, and the binding processing control unit 95 to be described later sets the moving amounts of the left and right side edge alignment plates 39F and 39R in accordance with the sheet sizes.

Note that in binding processing other than binding processing of binding the sheet corner, for example, in a multi-binding mode to be described later, the binding processing control unit 95 to be described later aligns a sheet with the center reference. In this case, the left and right side edge alignment plates 39F and 39R move from the standby positions toward the sheet center by the same amount, thereby positioning the sheet to the binding position.

This will be described with reference to FIG. 9. The binding unit 47 moves at the stroke SL1 between a standby position Wp1 (first standby position) and the binding position Cp1. That is, the binding unit 47 reciprocally moves between the standby position Wp1 and the binding position Cp1 along the traveling rails 53 and 54 (guide grooves or guide rods). The first standby position Wp1 is set outside the maximum size sheet to be bound on the processing tray 37.

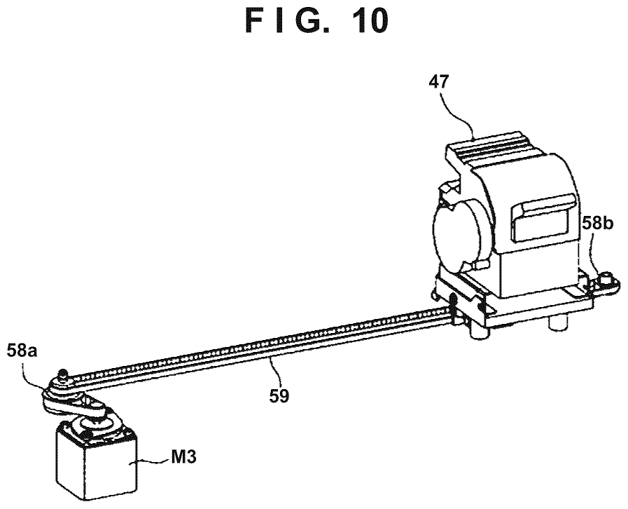

FIG. 10 shows the configuration of the binding unit 47. On the apparatus frame 27b, a pair of left and right pulleys 58a and 58b are arranged along the moving region (the left-and-right direction in FIG. 9) of the staple unit 47. A timing belt 59 (toothed belt) is stretched between the pulleys, and a driving motor M3 (stepping motor) is connected to one pulley 58a.

### Staple Moving Mechanism

As shown in FIG. 8, the staple unit 47 is mounted on the apparatus frame (chassis frame) 27b fixed to the side frames 70f and 70r through an opening portion provided in the side frame 70f of the apparatus frame 70. The first traveling rail 53 and the second traveling rail 54 are arranged on the apparatus frame 27b. A traveling rail surface 53x is formed on the first traveling rail 53, and a traveling cam surface 54x is formed on the second traveling rail 54. The traveling rail surface 53x and the traveling cam surface 54x cooperatively support the staple unit 47 (to be referred to as the “moving unit” hereinafter) such that the staple unit 47 can reciprocally move at the predetermined stroke, and simultaneously control the angular posture.

On the first traveling rail 53 and the second traveling rail 54, the rail surface 53x and the traveling cam surface 54x are formed such that the moving unit reciprocally moves in its moving range. As shown in FIG. 10, the timing belt 59 connected to the driving motor (traveling motor) M3 is fixed to the staple unit 47. The timing belt 59 is wound on the pair of pulleys 58a and 58b axially supported on the apparatus frame 27b, and the driving motor M3 is connected to one of the pulleys. Hence, when the driving motor M3 rotates in the forward and reverse directions, the staple unit 47 reciprocally moves at the stroke SL1.

The staple unit 47 engages with the first traveling rail 53 and the second traveling rail 54 in the following way. As shown in FIG. 8, the staple unit 47 is provided with a first rolling roller 83 (rail fitting member) that engages with the traveling rail surface 53x and a second rolling roller 84 (cam follower member) that engages with the traveling cam surface 54x. Also, sliding rollers 47x (two sliding rollers in FIG. 8) that have a ball shape and engage with the support surface of the frame 27b are formed on the staple unit 47. In addition, a guide roller 47y that engages with the bottom surface of a bottom frame is formed on the staple unit 47, thereby preventing the staple unit 47 from floating from the apparatus frame 27b.

With the above-described configuration, the staple unit 47 is supported on the apparatus frame 27b such that is can be moved by the sliding roller 47x and the guide roller 47y. Also, the first rolling roller 83 and the second rolling roller 84 travel in accordance with the rail surface 53x and the cam surface 54x, respectively, while rotating along the traveling rail surface 53x and the traveling cam surface 54x.

### Stack Tray Elevating Mechanism

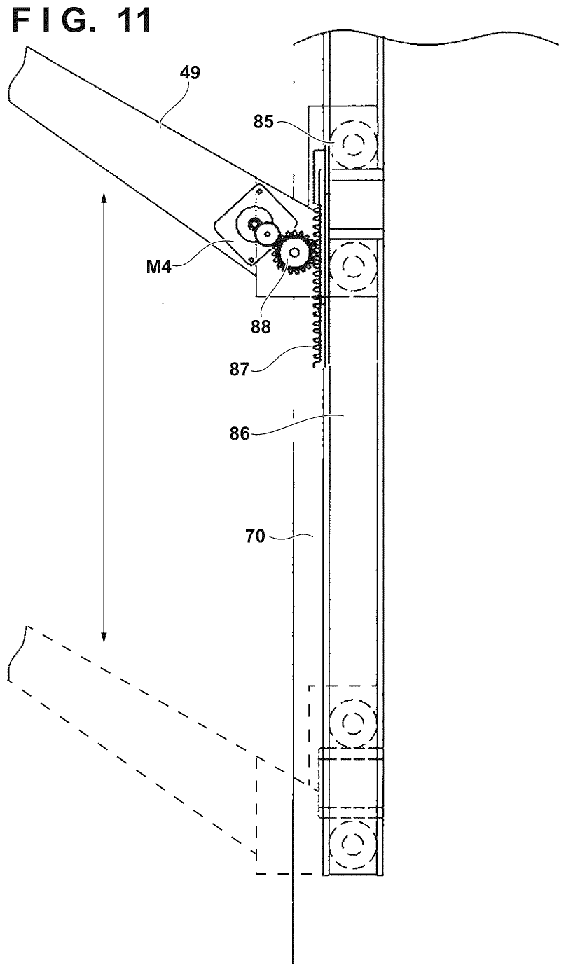

As shown in FIG. 11, the sheet post-processing apparatus B includes the first tray 49. The first tray 49 is configured to move up and down in accordance with the load amount of sheets. For this purpose, guide rollers 85 are provided at two points on the upper and lower sides at the proximal end portion of the first tray 49, and the guide rollers 85 are fitted and supported in an elevating guide 86 provided in the apparatus housing 27. An elevating gear 88 is provided at the proximal end portion of the first tray 49 and connected to an elevating rack gear 87. Also, an elevating motor M4 is connected to the elevating gear 88. Hence, the first tray 49 is moved up and down in accordance with the load amount of sheets by controlling rotation of the elevating motor M4.

### Sheet Bundle Unloading Mechanism

A sheet bundle unloading mechanism that unloads a sheet bundle that has undergone binding processing to the first tray 49 on the downstream side is arranged on the processing tray 37. As a configuration for conveying a sheet bundle to the downstream side, a method (unloading roller mechanism) of conveying a sheet bundle by rollers in pressure contact with each other and a conveyor mechanism that extrudes a sheet trailing edge by an extruding member that moves along the tray surface from the upstream side to the downstream side are known. The apparatus shown in the drawings employs both methods.

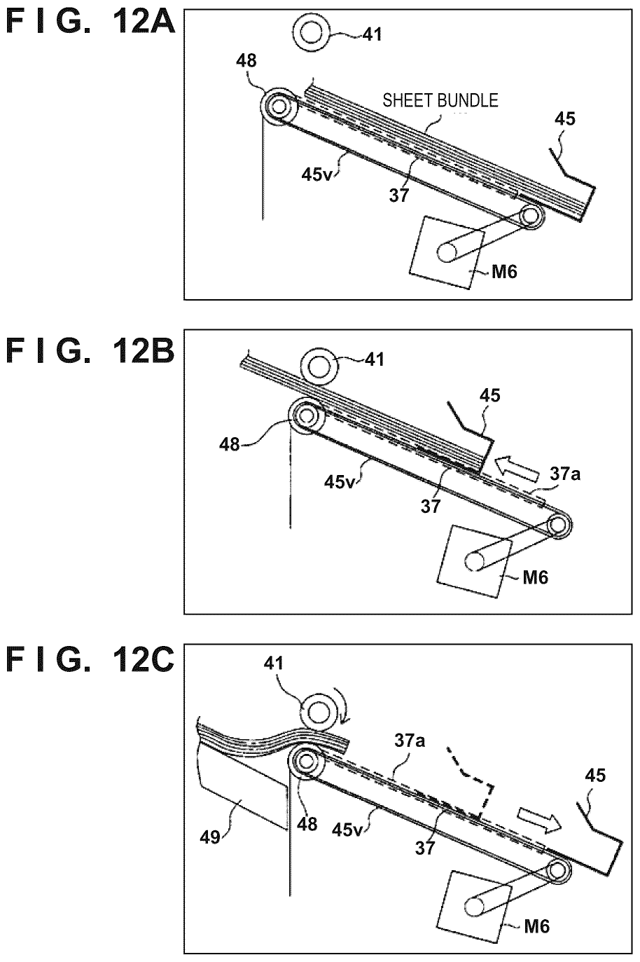

FIGS. 12A to 12C show the sheet bundle unloading mechanism. The conveyor mechanism is configured to include an extruding projection 45 that transfers a sheet bundle, along the processing tray 37, from the binding position (processing position) located on the upstream side to the stack tray (first tray) 49 on the downstream side, a conveyor belt 45v that moves the extruding projection, and a driving motor M6. On the processing tray 37, the driven roller 48 is arranged at the unloading port (the boundary between the sheet placement surface 37a and the first tray 49), and the elevating roller 41 in pressure contact with the driven roller 48 is arranged to face the driven roller 48. An unloading roller mechanism is formed by the driven roller 48 and the elevating roller 41.

Hence, the conveyor mechanisms 45 and 45v that transfer the sheet bundle by extruding it from the upstream side to the downstream side and the unloading roller mechanisms 48 and 41 that nip the sheet bundle and unload it are arranged on the processing tray 37. FIG. 12A shows a state in which the sheet bundle is located at the binding position on the processing tray 37. At this time, the conveyor mechanisms 45 and 45v and the unloading roller mechanisms 48 and 41 are set in an operating state. FIG. 12B shows a state halfway through transfer of the sheet bundle from the processing position to the downstream side. The sheet bundle is sent to the downstream side by movement of the extruding projection 45 and rotation of the unloading roller mechanisms 48 and 41. FIG. 12C shows a state immediately before unloading of the sheet bundle to the first tray 49 on the downstream side. On the processing tray, the sheet bundle is sent to the downstream side gradually (at a low speed) by rotation of the unloading roller mechanisms 48 and 41. At this time, the extruding projection 45 stands by at the position shown in FIG. 12C and returns (retreats) to the initial position.

### Configuration of Staple Unit

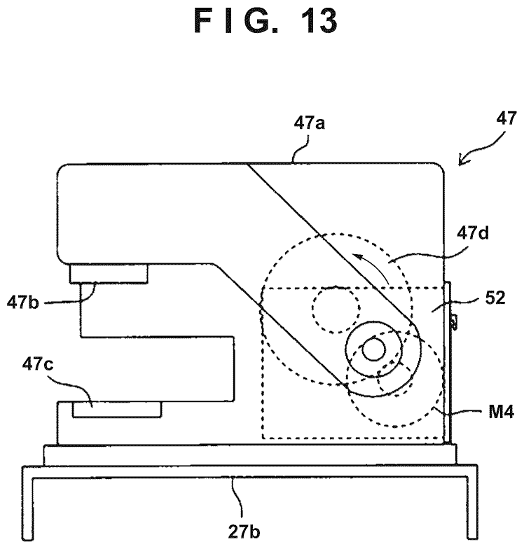

The configuration of the above-described staple unit will be described with reference to FIG. 13. The staple unit 47 is formed as a unit separately from the sheet post-processing apparatus B. A unit frame 47a having a box shape, a drive cam 47d swingably axially supported on the unit frame 47a, and the driving motor M4 that makes the drive cam 47d pivot are mounted in the unit frame 47a.

In the drive cam 47d, a staple head 47b and an anvil member 47c are arranged at the binding position to face each other. The staple head 47b is biased by a biasing spring (not shown) of the drive cam 47d from the standby position on the upper side to the staple position (anvil member) on the lower side and vertically moves. A needle cartridge 52 is detachably attached to the unit frame 47a.

The needle cartridge 52 stores linear blank needles, and the needles are supplied to the staple head 47b by a needle feed mechanism. The staple head portion 47b incorporates a former member that bends a linear needle into a U shape, and a driver that presses a bent needle into a sheet bundle. With this configuration, the drive cam 47d is rotated by the driving motor M4 to energize the biasing spring. When the rotation angle reaches a predetermined angle, the staple head portion 47b moves down to the side of the anvil member 47c with great force. By this operation, a staple needle is bent into a U shape and then inserted into the sheet bundle by the driver. The tips of the needle are bent by the anvil member 47c, thereby performing staple binding.

The needle feed mechanism is incorporated between the needle cartridge 52 and the staple head 47b, and a sensor (empty sensor) that detects absence of needles is arranged in the needle feed mechanism. Also, a cartridge sensor (not shown) that detects whether the needle cartridge 52 is inserted or not is arranged in the unit frame 47a.

The needle cartridge 52 employs a structure in which layers of staple needles connected in a band are stacked and stored in a cartridge having a box shape, and a structure in which staple needles are stored in a roll shape. The unit frame 47a is provided with a circuit that controls the above-described sensors, and a circuit board that controls the driving motor M4, and is configured to generate an alarm signal when the needle cartridge 52 is not stored or stable needles are absent. The staple control circuit is configured to control the driving motor M4 to execute the staple operation by a staple needle signal, and generate an “operation end signal” when the staple head portion 47b moves from the standby position to the staple position and returns to the standby position again.

### Explanation of Control Configuration

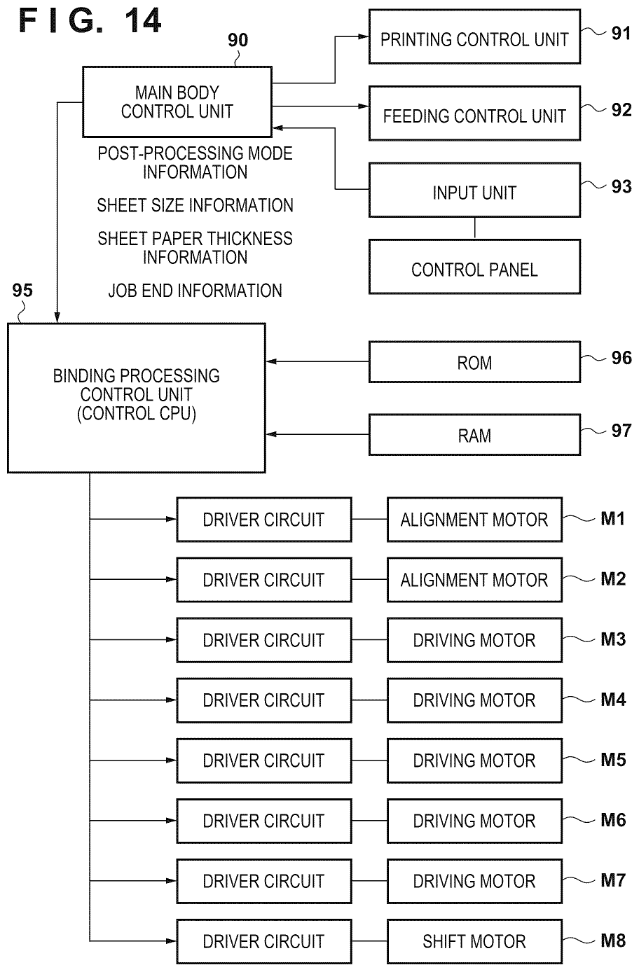

A control configuration in the image forming system shown in FIG. 1 will be described with reference to FIG. 14. The image forming system shown in FIG. 14 includes the control unit 90 (to be referred to as the “main body control unit” hereinafter) of the image forming apparatus A, and the control unit 95 (to be referred to as the “binding processing control unit” hereinafter) of the sheet post-processing apparatus B. The main body control unit 90 controls a printing control unit 91, a feeding control unit 92, and an input unit 93 (control panel).

“Image forming mode” and “post-processing mode” are set based on a user operation accepted via the input unit 93 (control panel). In the image forming mode, for example, a mode such as color/monochrome printing or doubles-sided/single-sided printing is set, and image forming conditions such as a sheet size, sheet quality, the number of printout copies, and resizing printing are set. Also, in the “post-processing mode”, for example, “printout mode”, “bookbinding processing discharge mode”, “staple binding processing mode”, or “jog sorting mode” is set.

Also, the main body control unit 90 transfers, to the binding processing control unit 95, data indicating that the mode is the post-processing mode and data indicating the number of sheets, copy count information, and paper thickness information of sheets to form images. At the same time, the main body control unit 90 transfers a job end signal to the binding processing control unit 95 every time image formation is ended.

The post-processing mode will be described. The “printout mode” is a mode in which sheets from the straight path discharge port 35 are stored in the stack tray 49 via the processing tray 37 without binding processing. In this case, the sheets are stacked on the processing tray 37 in an overlapped state, and a sheet bundle after stacking is unloaded to the stack tray 49 in accordance with the job end signal from the main body control unit 90.

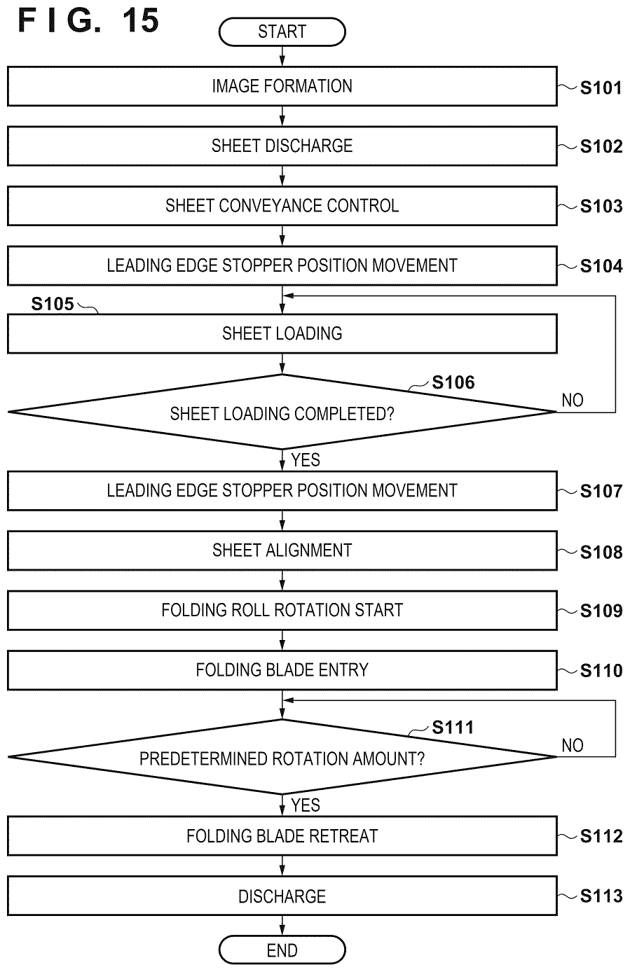

The “bookbinding processing discharge mode” is a mode in which sheets with images formed thereon are aligned and bound and then folded to perform bookbinding finishing. Details will be described with reference to FIG. 15.

The “staple binding processing mode” is a mode in which sheets from the straight path discharge port 35 are stacked and aligned on the processing tray 37, and the sheet bundle is bound and then stored in the stack tray 49. In this case, an operator designates such that the sheets to form images have the same paper thickness and the same size. In the staple binding processing mode, one of “multi-binding”, “right corner binding” and “left corner binding” is selected and designated.

In the “jog sorting mode”, sheets with images formed by the image forming apparatus A are divided into a group to be offset-moved and stacked and a group to be stacked without being offset-moved. Sheet bundles that are offset-moved and sheet bundles that are not offset-moved are alternately stacked on the stack tray.

### Binding Processing Control Unit

The binding processing control unit 95 causes the sheet post-processing apparatus B to operate in accordance with the post-processing mode set by the main body control unit 90. The binding processing control unit 95 is configured to include a control CPU. A ROM 96 and a RAM 97 are connected to the binding processing control unit 95, and the operation of the sheet post-processing apparatus B according to this embodiment is executed based on a control program stored in the ROM 96 and control data stored in the RAM 97. Hence, the binding processing control unit 95 controls the driver circuits of all the driving motors described above, thereby starting/stopping the motors and controlling forward/reverse rotations.

The bookbinding processing discharge mode that is one of the post-processing modes will be described with reference to FIG. 15. Steps S101 and S102 indicate processing in the image forming apparatus A, and steps S103 to S113 indicate processing in the sheet post-processing apparatus B. That is, the processes of steps S101 and S102 are implemented by, for example, the main body control unit 90 reading out a program stored in a ROM to a RAM and executing it. The processes of steps S103 to S113 are implemented by, for example, the binding processing control unit 95 reading out a program stored in the ROM 96 to the RAM 97 and executing it.

The main body control unit 90 forms an image on a sheet in step S101, and discharges the sheet with the image formed thereon in step S102. The sheet with the image formed by the image forming apparatus A is guided to the straight path 28.

In step S103, the binding processing control unit 95 controls the motors, thereby conveying the sheet discharged from the image forming apparatus A through the path up to the leading edge regulating stopper 67. The sheet conveyance control in step S103 will be described later.

In step S104, the binding processing control unit 95 moves the position of the leading edge regulating stopper 67 to a position at which a sheet can be loaded. At this time, the binding processing control unit 95 sets the position of the leading edge regulating stopper 67 based on the size of a sheet in the conveyance direction, which is received from the image forming apparatus A. In step S105, the binding processing control unit 95 loads a sheet to the leading edge regulating stopper 67 after movement. The loaded sheet abuts against the acceptance portion of the leading edge regulating stopper 67 and, therefore, the leading edges of sheets are aligned.

In step S106, the binding processing control unit 95 determines, based on a predetermined number to perform post-processing, whether the final sheet is loaded to the leading edge regulating stopper 67. The processing from step S105 is repeated until it is determined that the final sheet is loaded to the leading edge regulating stopper 67. Upon determining that the final sheet is loaded to the leading edge regulating stopper 67, the process advances to step S107.

In step S107, the binding processing control unit 95 moves the position of the leading edge regulating stopper 67 to which a predetermined number of sheets are loaded to the lowermost point. In step S108, the binding processing control unit 95 aligns the sheets in the widthwise direction. The sheet alignment here is performed by a side end regulating member (not shown).

In step S109, the binding processing control unit 95 rotates the folding roll pair 64. In step S110, the binding processing control unit 95 makes the folding blade 65 enter in the folding direction. In step S111, the binding processing control unit 95 determines whether the rotation amount of the folding roll pair 64 reaches a predetermined amount. Upon determining that the rotation amount of the folding roll pair 64 does not reach the predetermined amount, the process of step S111 is repeated. Upon determining that the rotation amount of the folding roll pair 64 reaches the predetermined amount, the process advances to step S112. In step S112, the binding processing control unit 95 causes the folding blade 65 to retreat. In step S113, the binding processing control unit 95 conveys the folded sheet that has undergone the above-described folding processing in the discharge direction by saddle unit discharge rollers on the downstream side. As a result, the folded sheet is stored in the second tray 61 via the saddle discharge path 68.

An example in which folding processing is performed after the position of the leading edge regulating stopper 67 is moved in step S107 has been described above, but the configuration is not limited to this. Another post-processing may be performed after the position of the leading edge regulating stopper 67 is moved and before folding processing is performed. For example, binding processing may be performed. For example, based on reception of a job end signal from the image forming apparatus A, a binding unit (saddle-stitch unit) (not shown) provided in the saddle unit B2 may be moved to the sheet center portion, and binding processing may be performed. At this time, binding processing is performed at defined positions, for example, at one point or two points.

Even during post-processing in the saddle unit B2, image formation is continuously performed by the image forming apparatus A. In this embodiment, a buffer operation of accumulating, in the sheet processing apparatus B, sheets conveyed from the image forming apparatus A is performed. This makes it possible to continuously perform post-processing without lowering the frequency of discharging sheets from the image forming apparatus A, that is, without lowering productivity of the image forming apparatus A.

The outline of the sheet buffer operation in the sheet processing apparatus B, which is executed in step S103, will be described with reference to FIGS. 16A to 23. FIGS. 16A to 23 are sectional views of the sheet processing apparatus B viewed from a side surface direction. The first conveyance roller 201, the second conveyance roller 202, and the third conveyance roller 203 will be referred to as the shift roller 201, the shift roller 202, and the intermediate conveyance roller 203, hereinafter.

First, the buffer operation of a sheet whose length in the sheet conveyance direction is small will be described. In this embodiment, as an example of definition of the small size, a size fitted in the path length of the straight path 28 is defined as the small size.

FIG. 16A shows a state in which in the saddle unit B2, the processes of steps S109 to S112 shown in FIG. 15 are performed for a sheet S0 previously existing in the sheet processing apparatus B. Also, FIG. 16A shows a state in which a sheet S1 discharged from the image forming apparatus A is conveyed up to the inlet rollers 29 and the shift rollers 201 via the straight path inlet 26. At this time, leading edge detection by the inlet sensor Se1 is performed. In the state shown in FIG. 16A, a lateral registration error to the sheet S1 (to be described later) is detected. FIG. 16B shows a state in which the leading edge of the sheet S1 is further conveyed up to a position exceeding the shift rollers 202. At this time, lateral registration adjustment for the sheet S1 (to be described later) is performed.

FIG. 17A shows a state in which the leading edge of the sheet S1 is further conveyed up to a position exceeding the discharge rollers 36. FIG. 17B shows a state in which the position of the upper flapper 33a is moved to a buffer path guide position. The buffer path guide position is set to a position where a sheet can be fed into the saddle buffer path P2 based on the leading edge detection result by the inlet sensor Se1 and sheet length information. Note that if the sheet reaches the discharge sensor Se2, the detection result of Se2 may be used instead or together.

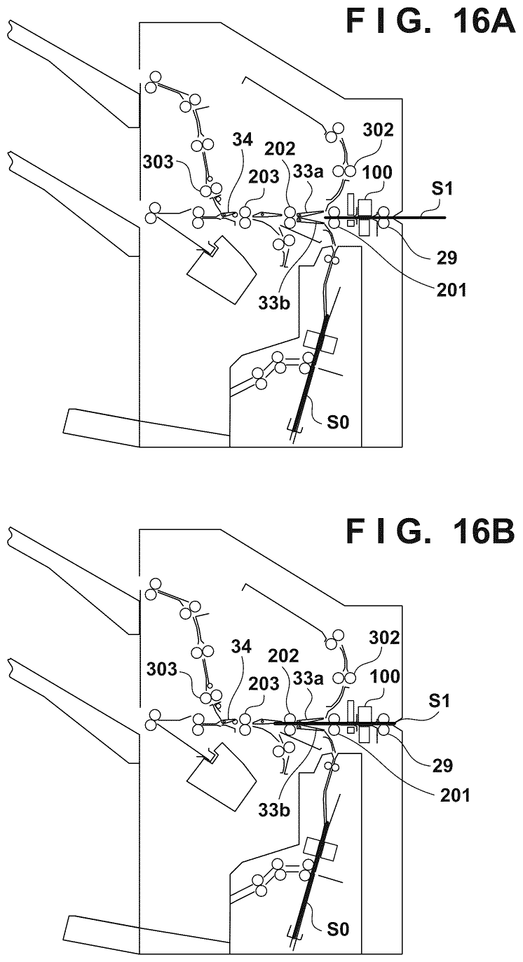

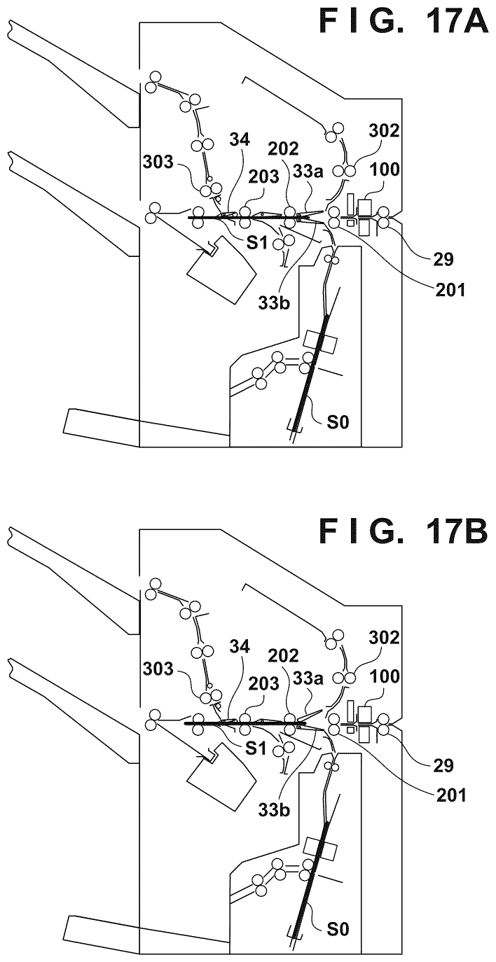

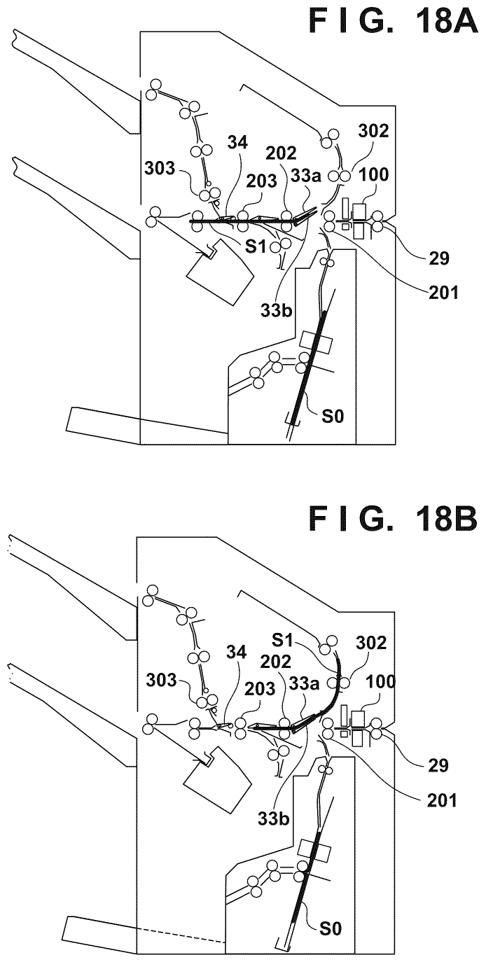

FIG. 18A shows a state in which the position of the lower flapper 33b is moved to the buffer path guide position. By moving the upper flapper 33a and the lower flapper 33b, a path to convey the sheet S1 to the saddle buffer path P2 is formed. FIG. 18B shows a state in which the sheet S1 is made to retreat to the saddle buffer path P2. Thus, in this embodiment, the sheet S1 is caused to retreat to the saddle buffer path P2, thereby continuously accepting, in the straight path 28, the sheet subsequently discharged from the image forming apparatus A. In FIG. 18B, post-processing (folding processing) for the sheet S0 is under execution. Here, “under execution” indicates not only folding processing but also a state in which folding processing itself is ended, but the sheet is not discharged yet to the second tray 61.

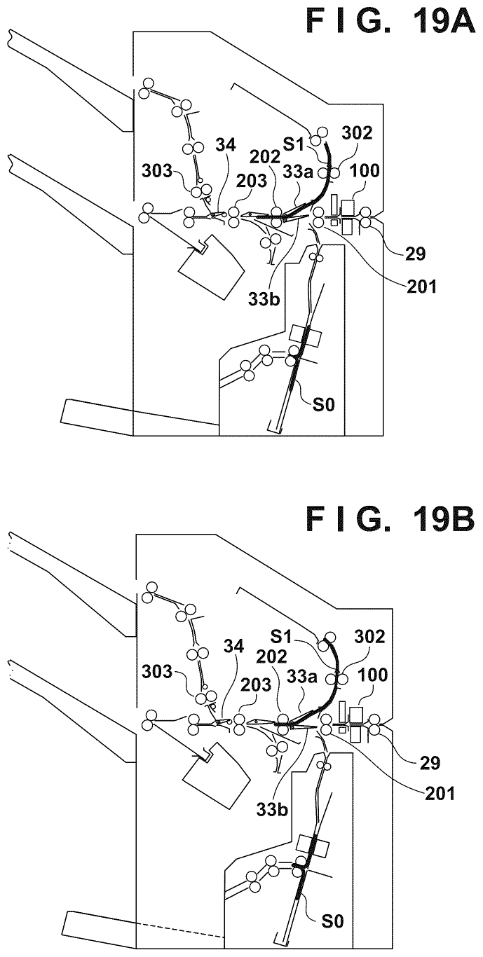

FIG. 19A shows a state in which the sheet S1 is further conveyed toward the fourth tray discharge port 305 of the saddle buffer path P2. At this time, post-processing for the sheet S0 is under execution. Also, FIG. 19B shows a state in which the position of the lower flapper 33b is moved. The lower flapper 33b is moved, thereby accepting a subsequent sheet S2 in the straight path 28.

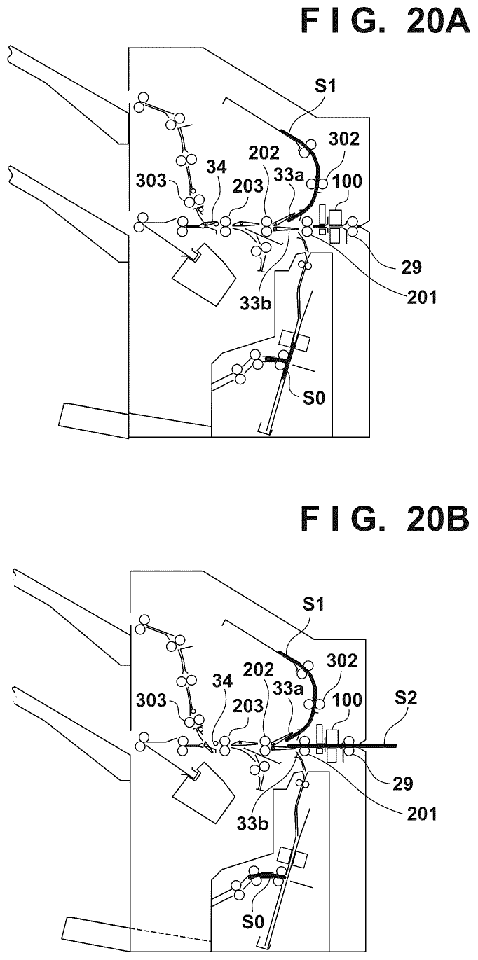

FIG. 20A shows a state in which the sheet S1 is located at a predetermined position in the saddle buffer path P2. As shown in FIG. 20A, the whole length of the sheet in the sheet conveyance direction is retreated to the saddle buffer path P2. Note that the retreat position in the saddle buffer path P2 is set based on the leading edge detection result by the inlet sensor Se1 and sheet length information. At this time, post-processing for the sheet S0 is under execution. FIG. 20B shows a state in which the sheet S2 subsequently discharged from the image forming apparatus A is conveyed to the inlet rollers 29 and the shift rollers 201 via the straight path inlet 26. At this time, leading edge detection for the sheet S2 by the inlet sensor Se1 is performed. In the state shown in FIG. 20B, lateral registration error detection (to be described later) for the sheet S2 is performed. At this time, lateral registration adjustment is performed such that the sheet S1 located in the saddle buffer path P2 is aligned in accordance with the lateral registration error of the sheet S2. The operation will be described later. At this time, post-processing for the sheet S0 is under execution.

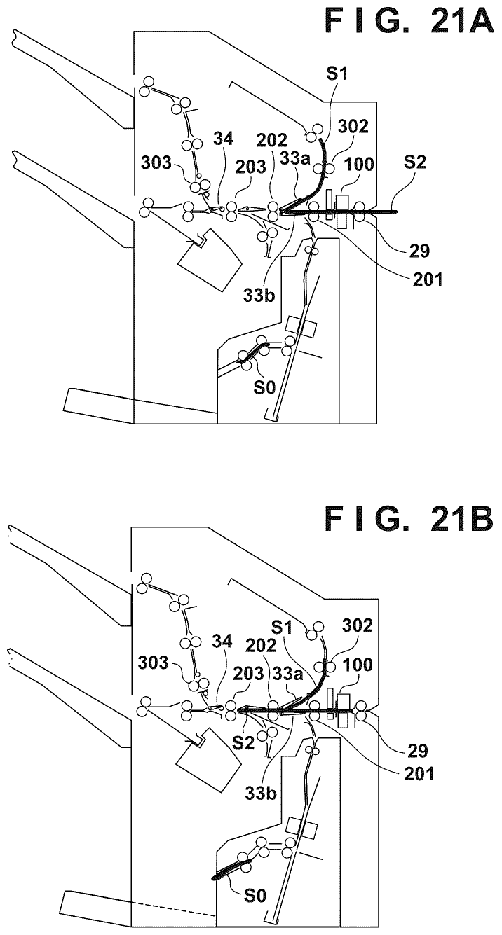

FIG. 21A shows a state in which the sheet S1 and the sheet S2 are conveyed up to the shift rollers 202 in synchronism. The conveyance synchronization between the sheets is executed based on, for example, the detection result of the inlet sensor Se1 and the sheet length information and sheet position information by the driving pulses of a stepping motor. By driving the buffer rollers 302 based on the leading edge detection result of the sheet S2 by the inlet sensor Se1, the sheet S1 is aligned with the leading edge of the sheet S2 and fed into the straight path 28. At this time, post-processing for the sheet S0 is under execution. FIG. 21B shows a state in which the sheet S1 and the sheet S2 are further conveyed to before the intermediate conveyance rollers 203 in synchronism. At this time, lateral registration adjustment is performed such that the sheet S1 and the sheet S2 are aligned with the center. The operation will be described later. At this time, post-processing for the sheet S0 is under execution.

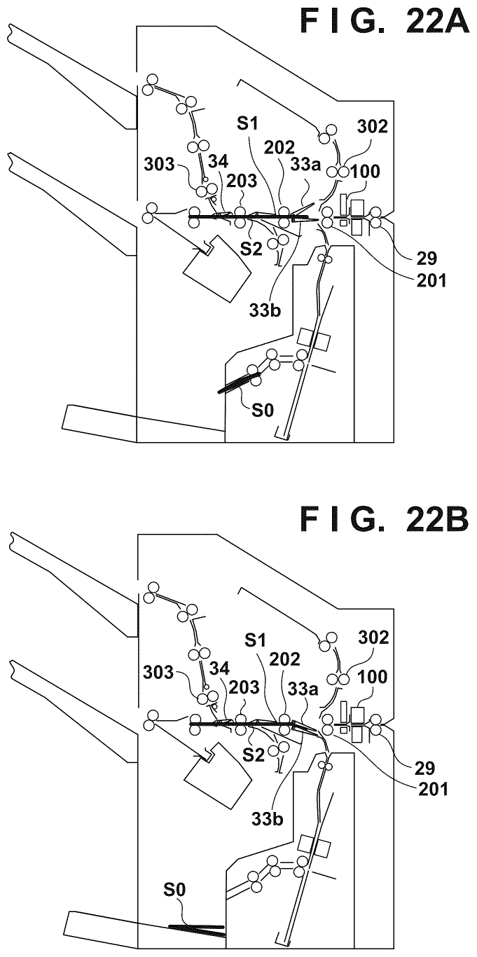

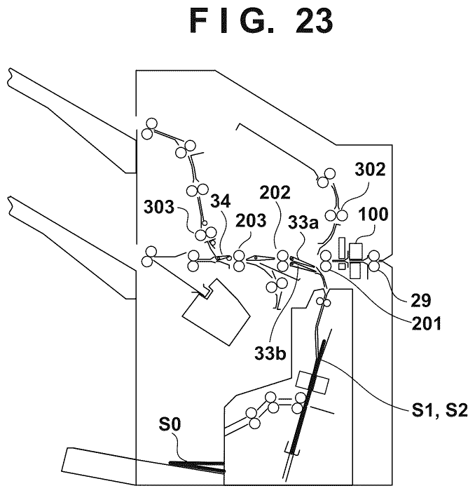

FIG. 22A shows a state in which the sheet S1 and the sheet S2 are conveyed up to the discharge rollers 36 in an overlapped state. At this time, the trailing edges of the sheet S1 and the sheet S2 leave the shift rollers 201. Also, at this time, post-processing for the sheet S0 is under execution. FIG. 22B shows a state in which the positions of the upper flapper 33a and the lower flapper 33b are moved. When the upper flapper 33a and the lower flapper 33b are moved, a path to convey the sheet S1 and the sheet S2 to the saddle unit B2 is formed. At this time, the sheet S0 is discharged to the second tray 61. FIG. 23 shows a state in which the sheet S1 and the sheet S2 are loaded to the leading edge regulating stopper 67.

As described above, according to this embodiment, even if post-processing for the sheet is under execution in the saddle unit B2, it is possible to retreat the sheet S1 to the saddle buffer path P2 and accept the subsequent sheet S2 from the image forming apparatus A. This makes it possible to execute post-processing for the sheet without lowering productivity of the image forming apparatus A. In addition, since the leading edge is made to abut against the leading edge regulating stopper 67, the sheets S1 and S2 are stacked sequentially from the lower side in the stacked state, and the order of the plurality of sheets is maintained. Furthermore, since the buffered sheets S1 and S2 are fed into the saddle unit B2 in the aligned state and, therefore, the bundle of the buffered sheets can quicky retreat from the straight path 28, the timing to accept the next sheet can be advanced. Note that a state in which the buffered sheets S1 and S2 are relatively aligned is a state in which the deviation amount in the conveyance direction falls within a predetermined range, for example, a range from 0 mm to +10 mm and a range from 0 mm to −10 mm. In this embodiment, adjustment is performed using, as a standard value, a state in which the preceding sheet S1 that has entered the saddle buffer path P2 by, for example, about 2.5 mm with respect to the subsequent sheet S2 is located on the trailing edge side. This makes it possible to, when the sheet bundle of the sheet S1 and the sheet S2 is fed into the saddle unit B2, make the sheet S1 located on the right side abut against the leading edge regulating stopper 67 first and facilitate alignment of sheets. Even if various kinds of tolerances are taken into consideration, when control is done such that the trailing edge of the sheet S1 is located behind the sheet S2 within a predetermined range, the timing of quickly retreating the sheets from the straight path 28 can be guaranteed, and productivity can be improved by more quickly accepting the next sheet.

Note that when the inlet to the saddle path 32 and the position at which overlap of sheets is completed (the outlet of the saddle buffer path P2) are provided at close positions in the conveyance direction, the conveyance distance to make the sheet retreat from the straight path 28 is short, and productivity is improved. In addition, the saddle buffer path flapper 33a and the saddle path flapper 33b, which are configured to feed a sheet from the straight path 28 to the paths, can be shared. When the operation of feeding a sheet to the saddle buffer path P2 is performed two or more times, buffer processing of three or more sheets can be performed.

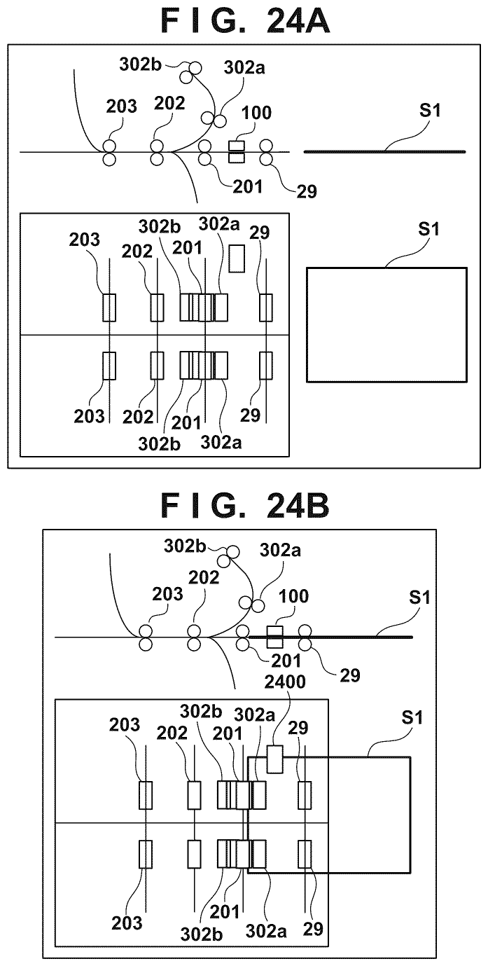

In a part of FIGS. 16A to 23, lateral registration error detection and lateral registration adjustment are performed. The lateral registration error detection and the lateral registration adjustment will be described below with reference to FIGS. 24A to 33B. The upper portions of FIGS. 24A to 33B are views showing a simplified configuration near the straight path 28 in FIGS. 16A to 23. The lower portions of FIGS. 24A to 33B are views of the straight path 28 in the upper portions viewed from the upper side of the apparatus. Also, the inlet rollers 29, the shift rollers 201, the shift rollers 202, the intermediate conveyance rollers 203, and the buffer rollers 302a and 302b shown in the lower portions of FIGS. 24A to 33B correspond to the inlet rollers 29, the shift rollers 201, the shift rollers 202, the intermediate conveyance rollers 203, and the buffer rollers 302a and 302b shown in the upper portions of FIGS. 24A to 33B, respectively. Also, as shown in the upper portions, in the rollers arranged on the straight path 28, roller pairs look overlapping each other when viewed from the upper side. On the other hand, as for the rollers arranged on the saddle buffer path P2, roller pairs look shifted from each other when viewed from the upper side because the e conveyance path is curved, and the state is shown.

FIG. 24A shows a state in which the sheet S1 is discharged from the image forming apparatus A. At this time, the center axis of the sheet S1 is normally not located on the center in the widthwise direction, and a lateral registration error is generated. FIG. 24B shows a state in which the sheet S1 is conveyed to before the shift rollers 201. At this time, detection of the lateral registration error of the sheet S1 by a registration detection sensor 2400 is performed.

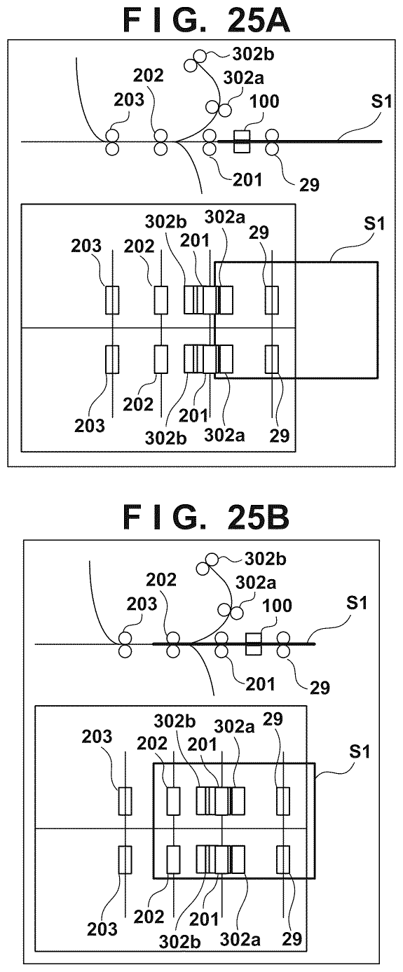

FIG. 25A shows a state in which detection of the lateral registration error of the sheet S1 by the registration detection sensor 2400 is ended. FIG. 25B shows a state in which the sheet S1 is conveyed up to a position exceeding the shift rollers 202. At this time, the nip of the inlet rollers 29 is canceled. In other words, the sheet S1 is nipped by the shift rollers 201 and the shift rollers 202. The shift rollers 201 and the shift rollers 202 can be shift-moved by the above-described conveyance roller shift mechanism.

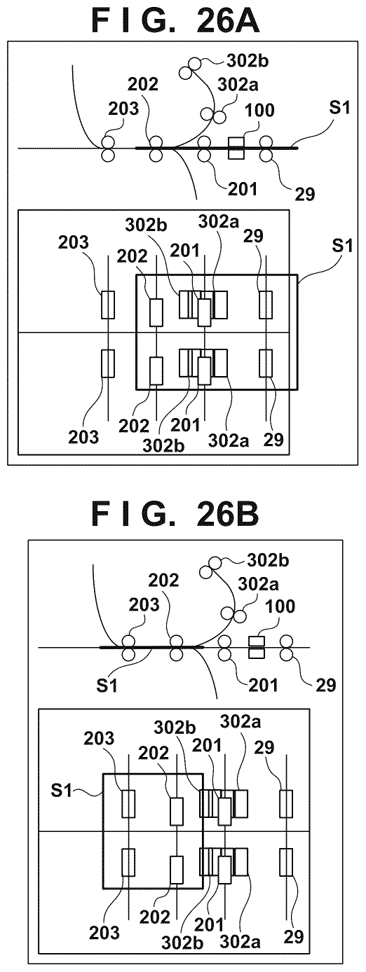

In FIG. 26A, lateral registration adjustment is performed by the shift roller 201 and the shift rollers 202 such that the center axis of the sheet S1 in the conveyance direction is aligned with the center. This corresponds to the state shown in FIG. 16B. FIG. 26B shows a state in which the sheet S1 is conveyed up to a position exceeding the intermediate conveyance rollers 203. At this time, the inlet rollers 29 is in a nip state, and the subsequent sheet can be accepted.

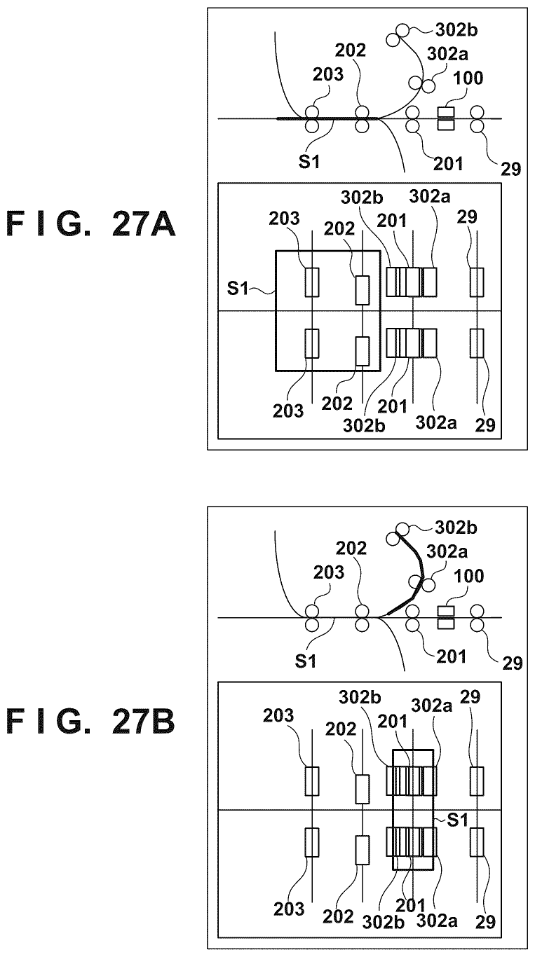

FIG. 27A shows a state in which the position of the shift rollers 201 is returned to the original position (acceptance position). FIG. 27B shows a state in which the sheet S1 is conveyed reversely to the saddle buffer path P2 by the intermediate conveyance rollers 203, the shift rollers 202, and the buffer rollers 302a and 302b. That is, in the state shown in FIG. 27B, the intermediate conveyance rollers 203 and the shift rollers 202 are controlled to operate reversely. At this time, the upper flapper 33a and the lower flapper 33b are moved, as shown in FIG. 18A.

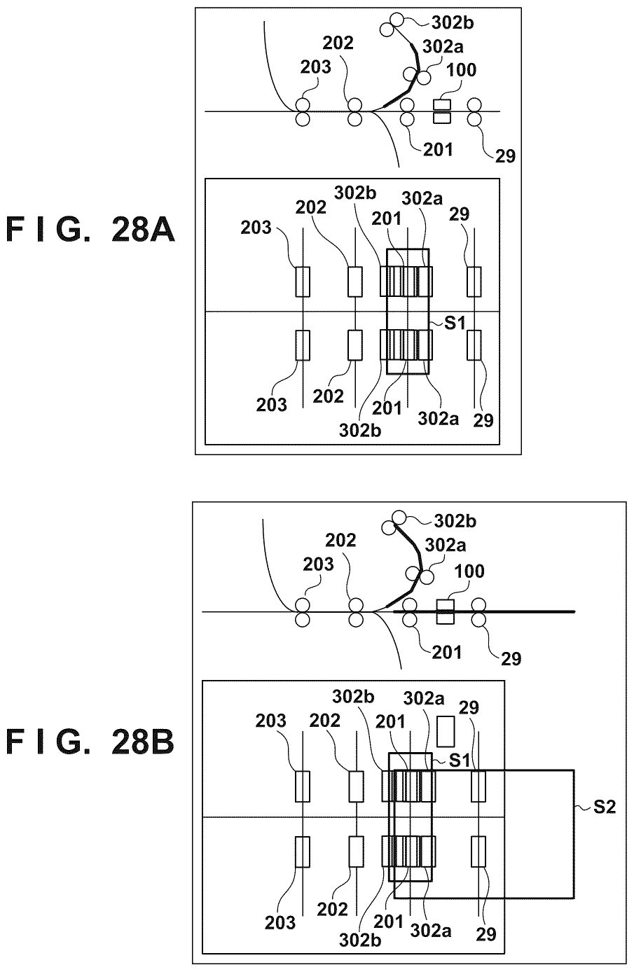

FIG. 28A shows a state in which the position of the shift rollers 202 is returned to the original position (acceptance position). FIG. 28B shows a state in which the sheet S2 is subsequently discharged from the image forming apparatus A and conveyed up to a position exceeding the shift rollers 201. At this time, the center axis of the sheet S2 is not located on the center in the widthwise direction, and a lateral registration error is generated.

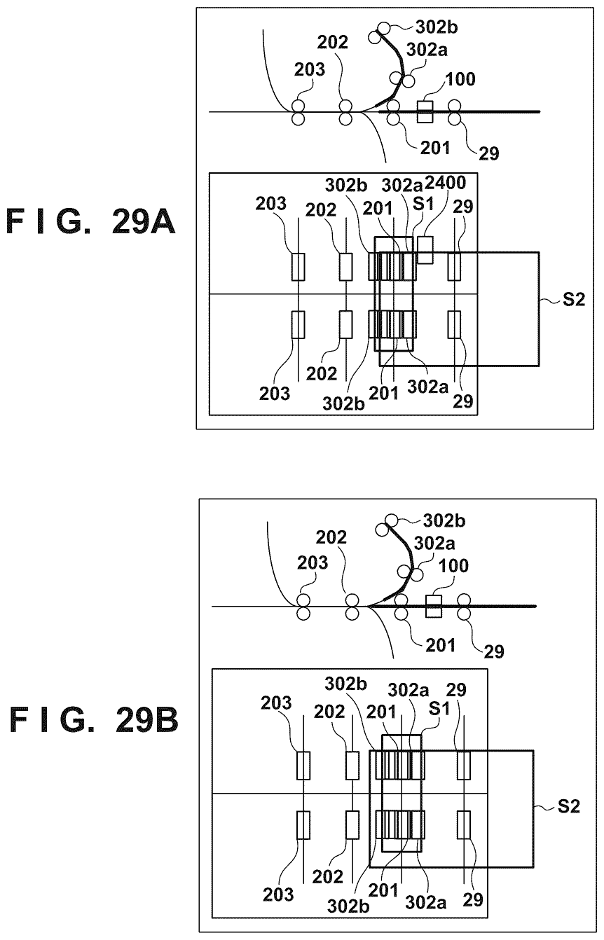

FIG. 29A shows a state in which detection of the lateral registration error of the sheet S2 by the registration detection sensor 2400is performed. FIG. 29B shows a state in which detection of the lateral registration error of the sheet S2 by the registration detection sensor 2400is ended, and the sheet S2 is further conveyed to before the shift rollers 202.

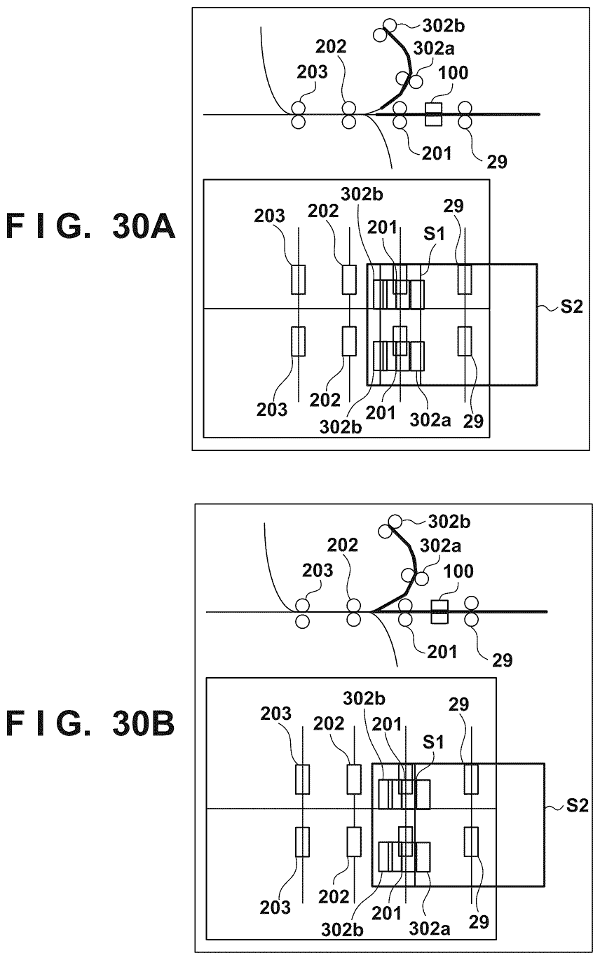

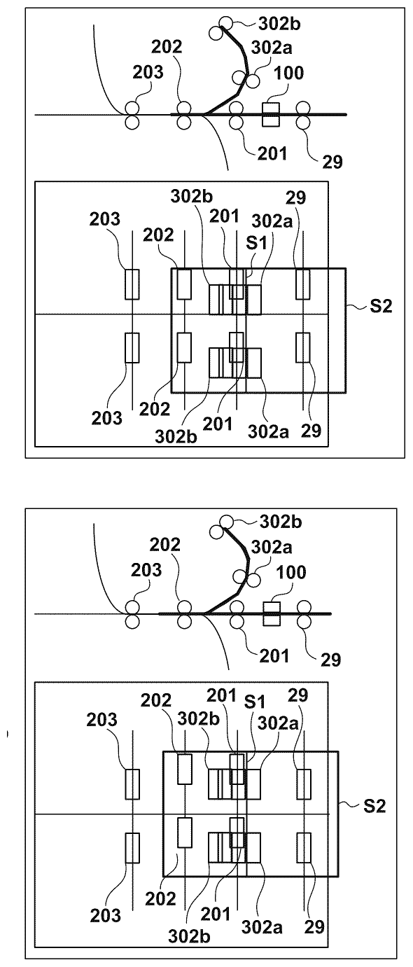

FIG. 30A is a view showing a state in which lateral registration adjustment is performed for the sheet S1 located in the saddle buffer path P2 by the shift operation of the buffer rollers 302a and 302b in accordance with the lateral registration error of the sheet S2. That is, the first shift operation for the sheet S1 is performed. This corresponds to the state shown in FIG. 21A. The buffer rollers 302a and 302b can be shift-moved by the above-described conveyance roller shift mechanism. FIG. 30B shows a state in which the sheet S1 and the sheet S2 are conveyed to the downstream side of the straight path 28 in synchronism.

FIG. 31A shows a state in which the sheet S1 and the sheet S2 are synchronously conveyed up to a position exceeding the shift rollers 202. At this time, the nip of the inlet rollers 29 is canceled. In other words, the sheet S2 overlaps the sheet S1 and is nipped by the shift rollers 201 and the shift rollers 202. FIG. 31B is a view showing a state in which lateral registration adjustment is performed such that the sheet S1 and the sheet S2 are aligned with the center by the shift operation of the shift rollers 201 and 202 and the buffer rollers 302a and 302b. This corresponds to the state shown in FIG. 21B. That is, the second shift operation is performed for the sheet S1.

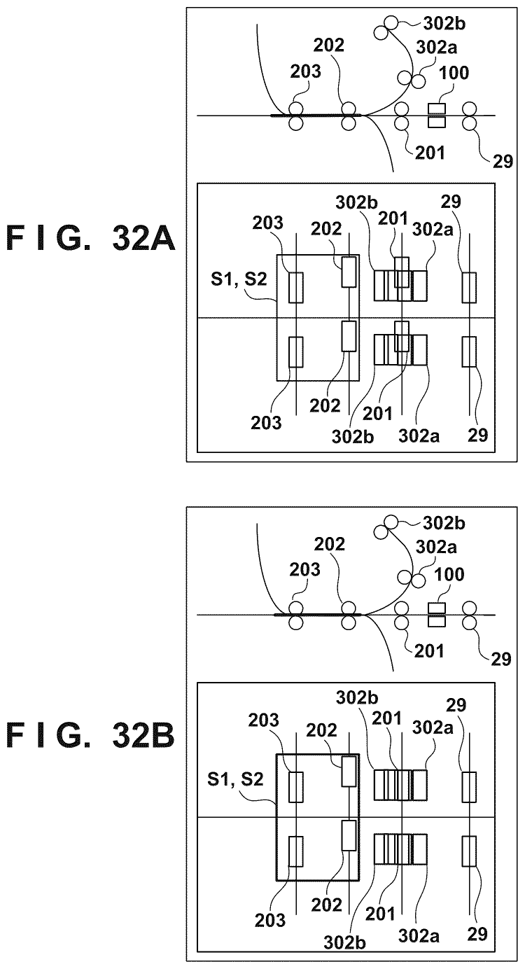

FIG. 32A is a view showing a state in which the sheet S1 and the sheet S2 are conveyed up to a position exceeding the intermediate conveyance rollers 203 in an overlapped state. FIG. 32B is a view showing a state in which the shift rollers 201 are moved to the original position (acceptance position). At this time, the upper flapper 33a and the lower flapper 33b are moved to positions where the sheet can be guided to the saddle path 32, as shown in FIG. 22B.

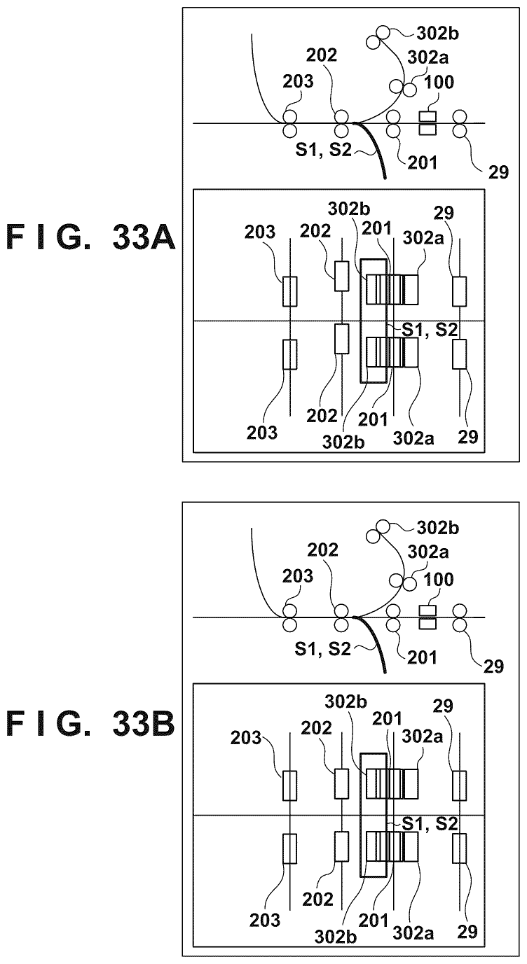

FIG. 33A is a view showing a state in which the sheet S1 and the sheet S2 are conveyed up to the saddle path 32 in an overlapped state. FIG. 33B is a view showing a state in which the shift rollers 202 are moved to the original position (acceptance position).

As described above, according to this embodiment, it is possible to adjust the registration error of each of the sheets discharged from the image forming apparatus A and continuously accepted by the straight path 28.

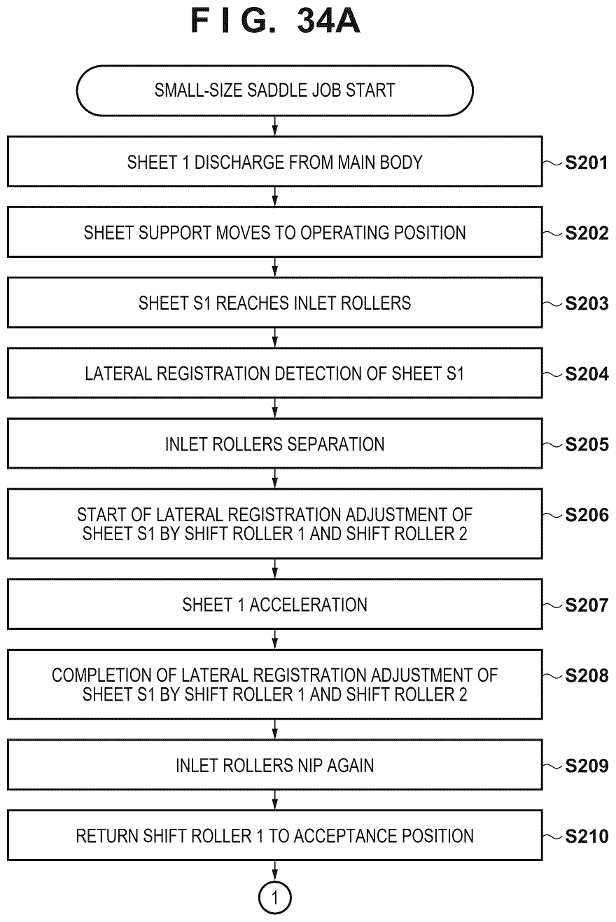

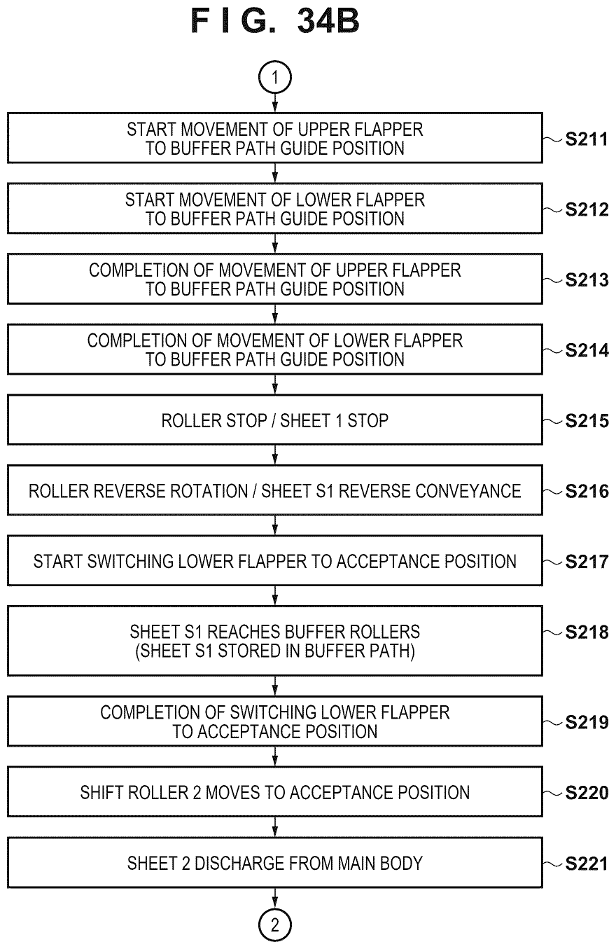

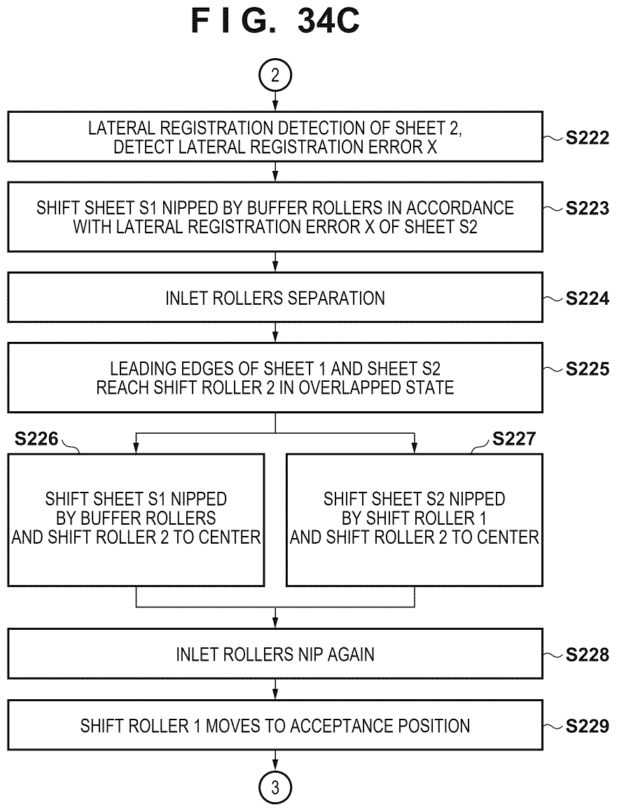

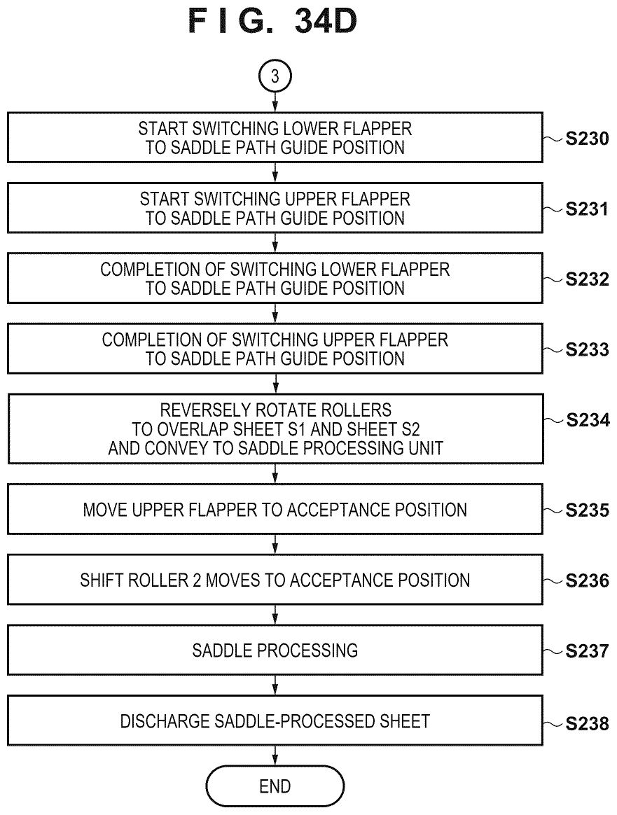

FIGS. 34A to 34D are flowcharts showing processing of the sheet buffer operation executed by the sheet processing apparatus B. The processing shown in FIGS. 34A to 34D is implemented by, for example, the binding processing control unit 95 reading out a program stored in the ROM 96 to the RAM 97 and executing it. Note that the binding processing control unit 95 according to this embodiment is one control unit but may be a combination of individual control units corresponding to the rollers.

In step S201, the sheet S1 is discharged from the image forming apparatus A. The process of step S201 is executed by the image forming apparatus A. In step S202, the binding processing control unit 95 moves a sheet support to the operation position. The sheet support is a member configured to prevent the sheet conveyed on the straight path 28 from falling. In step S203, the binding processing control unit 95 detects that the sheet S1 reaches the inlet rollers 29. In step S204, the binding processing control unit 95 detects the lateral registration error of the sheet S1 by the registration detection sensor 2400.

In step S205, the binding processing control unit 95 separates the inlet rollers 29 (nip cancel). This is to perform lateral registration adjustment of the sheet S1 by the shift operation of the shift rollers 201 and the shift rollers 202 at the subsequent stage. In step S206, the binding processing control unit 95 starts the shift operation of the shift rollers 201 and the shift rollers 202. Here, the shift direction is the direction to cancel the lateral registration error of the sheet S1. In step S207, the binding processing control unit 95 accelerates the sheet S1 and conveys it to the downstream side of the straight path 28. In step S208, the binding processing control unit 95 completes the shift operation of the shift rollers 201 and the shift rollers 202.

In step S209, the binding processing control unit 95 sets the inlet rollers 29 in the nip state again. In step S210, the binding processing control unit 95 returns the shift rollers 201 to the original position (acceptance position). This corresponds to the state shown in FIG. 27A.

The binding processing control unit 95 starts moving the upper flapper 33a to the buffer path guide position in step S211 and starts moving the lower flapper 33b to the buffer path guide position in step S212. In step S213, the binding processing control unit 95 completes movement of the upper flapper 33a to the buffer path guide position, and in step S214, the binding processing control unit 95 completes movement of the lower flapper 33b to the buffer path guide position. This corresponds to the state shown in FIG. 18A.

In step S215, the binding processing control unit 95 stops the shift rollers 202 and the intermediate conveyance rollers 203. In step S216, the binding processing control unit 95 reversely operates the shift rollers 202 and the intermediate conveyance rollers 203, thereby reversely conveying the sheet S1. In step S217, the binding processing control unit 95 starts moving the lower flapper 33b to the original position (acceptance position). In step S218, the binding processing control unit 95 makes the sheet S1 retreat to the saddle buffer path P2. In step S219, the binding processing control unit 95 completes movement of the lower flapper 33b to the original position. This corresponds to the state shown in FIG. 19B. In step S220, the binding processing control unit 95 moves the shift rollers 202 to the original position (acceptance position). This corresponds to the state shown in FIG. 28A.

In step S221, the sheet S2 is discharged from the image forming apparatus A. The process of step S221 is executed by the image forming apparatus A.

In step S222, the binding processing control unit 95 detects the lateral registration error of the sheet S2 by the registration detection sensor 2400. In step S223, the binding processing control unit 95 performs lateral registration adjustment by the shift operation of the buffer rollers 302a and 302b such that the sheet S1 located in saddle buffer path P2 is aligned in accordance with the lateral registration error of the sheet S2.

In step S224, the binding processing control unit 95 separates the inlet rollers 29 (nip cancel). This is to perform lateral registration adjustment of the sheet S1 and the sheet S2 by the shift operation of the shift rollers 201 and 202 and the buffer rollers 302a and 302b at the subsequent stage.

In step S225, the binding processing control unit 95 makes the sheet S1 and the sheet S2 overlap and conveys these up to the shift rollers 202.

In step S226, the binding processing control unit 95 performs registration adjustment by the shift operation of the buffer rollers 302a and 302b and the shift rollers 202 such that the center axis of the sheet S1 is aligned with the center. On the other hand, in step S227, the binding processing control unit 95 performs registration adjustment by the shift operation of the shift rollers 201 and the shift rollers 202 such that the center axis of the sheet S2 is aligned with the center. The process of step S226 and the process of step S227 are simultaneously performed in parallel.

In step S228, the binding processing control unit 95 sets the inlet rollers 29 in the nip state again. In step S229, the binding processing control unit 95 returns the shift rollers 201 to the original position (acceptance position). This corresponds to the state shown in FIG. 32B.

The binding processing control unit 95 starts moving the lower flapper 33b to the saddle path guide position in step S230 and starts moving the upper flapper 33a to the saddle path guide position in step S231. The binding processing control unit 95 completes movement of the lower flapper 33b to the saddle path guide position in step S232, and completes movement of the upper flapper 33a to the saddle path guide position in step S233. This corresponds to the state shown in FIG. 22B.

In step S234, the binding processing control unit 95 reversely operates the intermediate conveyance rollers 203 and the shift rollers 202, thereby making the sheet S1 and the sheet S2 overlap and reversely conveying these to the saddle path 32.

The operation of making the sheet S1 and the sheet S2 overlap shown in FIGS. 20B and 21A will be described in detail. The leading edge of the sheet S1 in the conveyance direction is located on the upstream side of the nip point of the shift rollers 202 in the conveyance direction. If the sheet S1 and the sheet S2 are to be merged at the nip point where the sheets are made to overlap and nipped or on the downstream side of the nip point, the sheet S1 may contact the sheet S2, impeding conveyance and disabling merging. Particularly in bookbinding processing, a paper type of high grammage (for example, a grammage of 256 g/m²) is used as covers and a paper type of grammage lower than that of the covers is used as inside pages in many cases. Since thin paper of a grammage of 52 to 82 g/m² generally used as inside pages is flimsy paper and readily causes bending, merging is difficult.

After the sheet S1 and the sheet S2 are made to overlap, the sheet S1 is buffered in the saddle buffer path P2 such that it can be nipped by a roller pair, the motor that drives the conveyance rollers and the motor that drives buffer rollers are adjusted such that the speed of the sheet S2 substantially equals the speed of the sheet S1, and the sheet S1 and the sheet S2 are merged.

More specifically, for example, using the detection result of the inlet sensor Se1 or the detection result of another sheet position sensor (not shown), the sheet is made to stand by at a position where the leading edge of the sheet S1 is drawn into the saddle buffer path P2 by about 3 mm from the straight path 28, that is, a position where the leading edge of the sheet S1 is not exposed to the straight path 28, and the sheet S1 is accelerated to the conveyance speed of the sheet S2 and merged in the straight path 28 before the leading edge of the sheet S2 arrives at the shift rollers 202. Thus, flaws caused by contact between the sheets can be prevented, and the sheet S1 and the sheet S2 can smoothly be merged.

In step S235, the binding processing control unit 95 moves the upper flapper 33a to the original position (acceptance position). In step S236, the binding processing control unit 95 moves the lower flapper 33b to the original position (acceptance position).

In step S237, the binding processing control unit 95 executes saddle processing for the sheet S1 and the sheet S2 loaded to the leading edge regulating stopper 67. This corresponds to the processes of steps S109 to S111 in FIG. 15. In step S238, the binding processing control unit 95 stores the sheet S1 and the sheet S2, which have undergone the saddle processing, in the second tray 61 via the saddle discharge path 68 (discharge portion). After that, the processing shown in FIGS. 34A to 34D is ended.

Concerning the buffer operation of a sheet of a large size whose length i the sheet conveyance direction is larger in the conveyance direction than the small size, points different from the case of the small size will be described below.

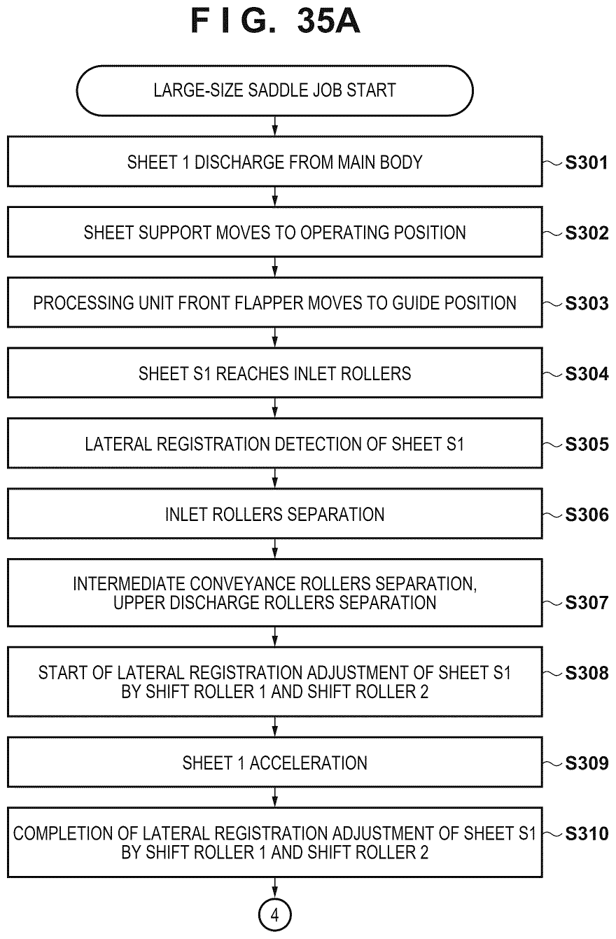

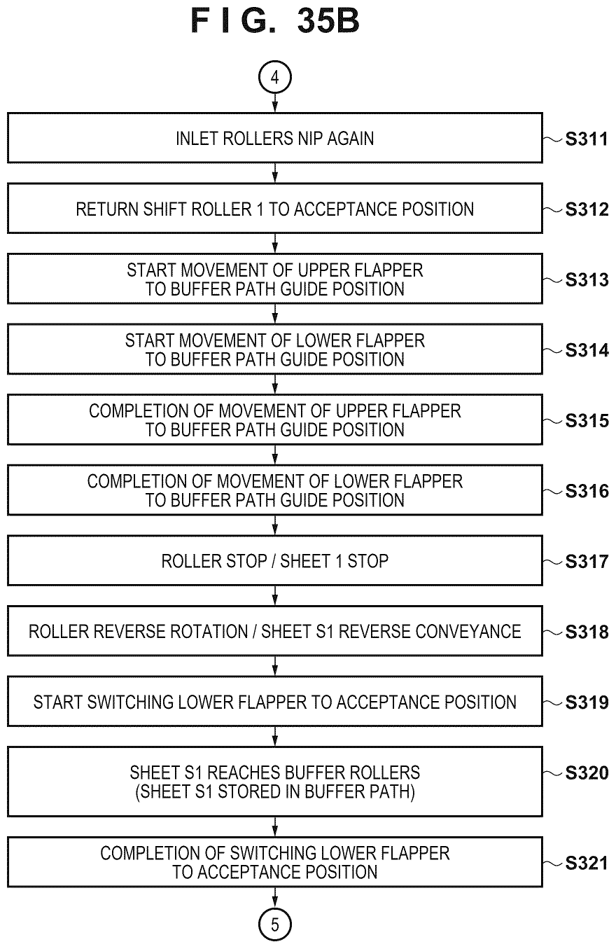

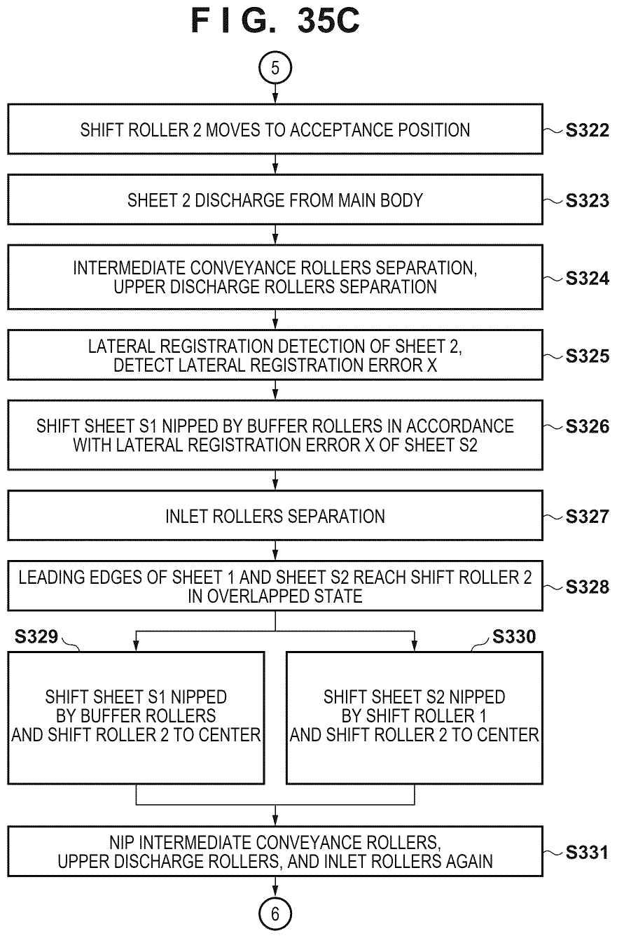

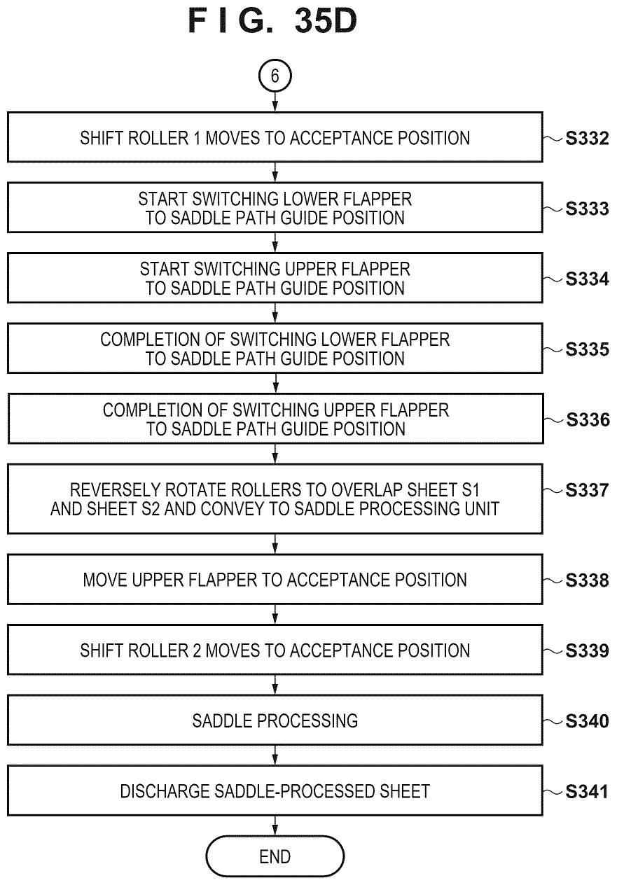

FIGS. 35A to 35D are flowcharts showing processing of the buffer operation of a sheet of a large size executed by the sheet processing apparatus B. The processing shown in FIGS. 35A to 35D is implemented by, for example, the binding processing control unit 95 reading out a program stored in the ROM 96 to the RAM 97 and executing it. The processing shown in FIGS. 35A to 35D is different from FIGS. 34A to 34D in that the processes of steps S303, S307, S311, S324, and S331 are performed. The processes of steps S301, S302, S304 to S306, S308 to S310, S312 to S323, S325 to S330, and S332 to S341 are the same as described concerning steps S201, S202, S203 to S205, S206 to S208, S210 to S221, S222 to S227, and S229 to S238, and a description thereof will be omitted.

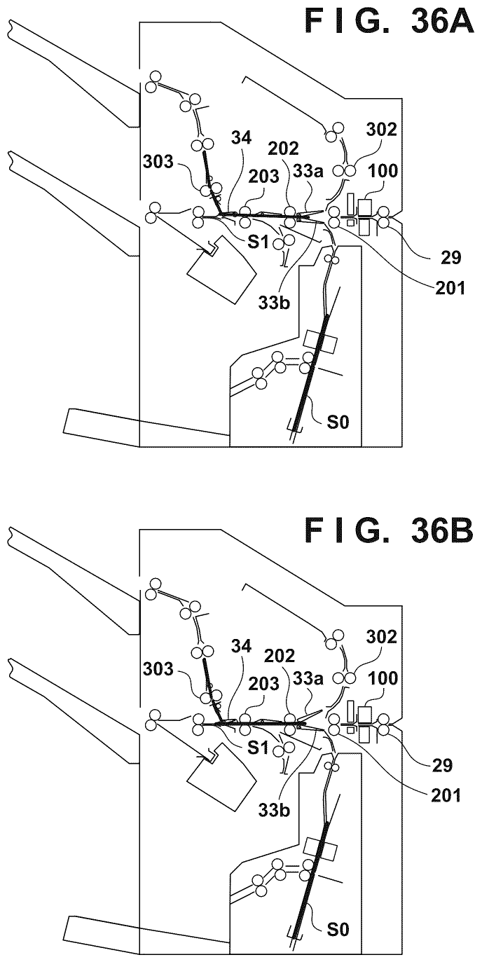

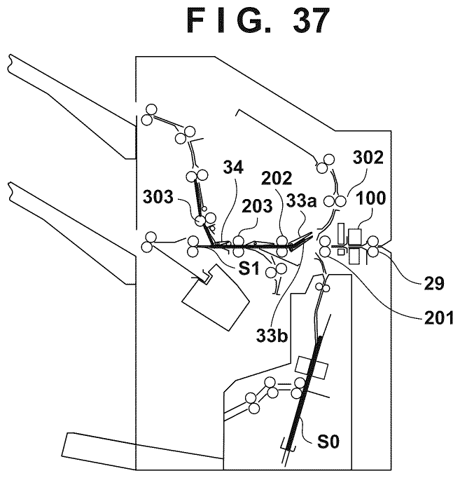

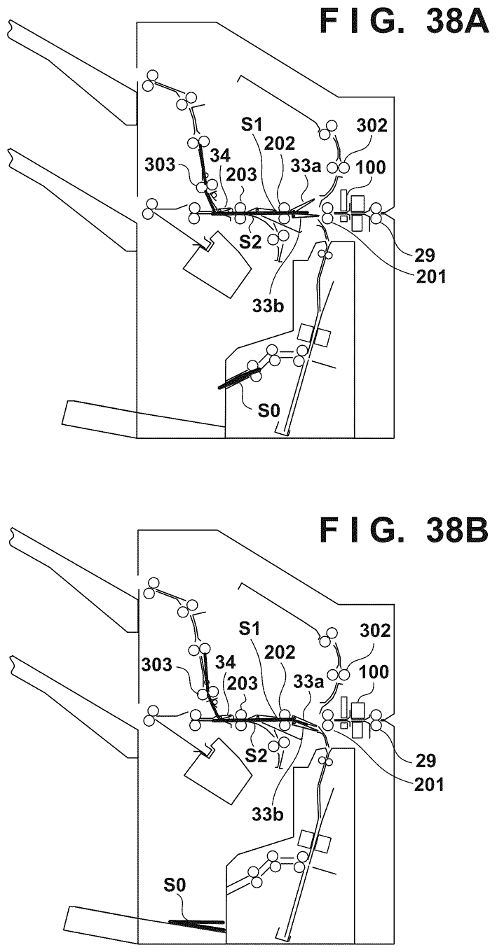

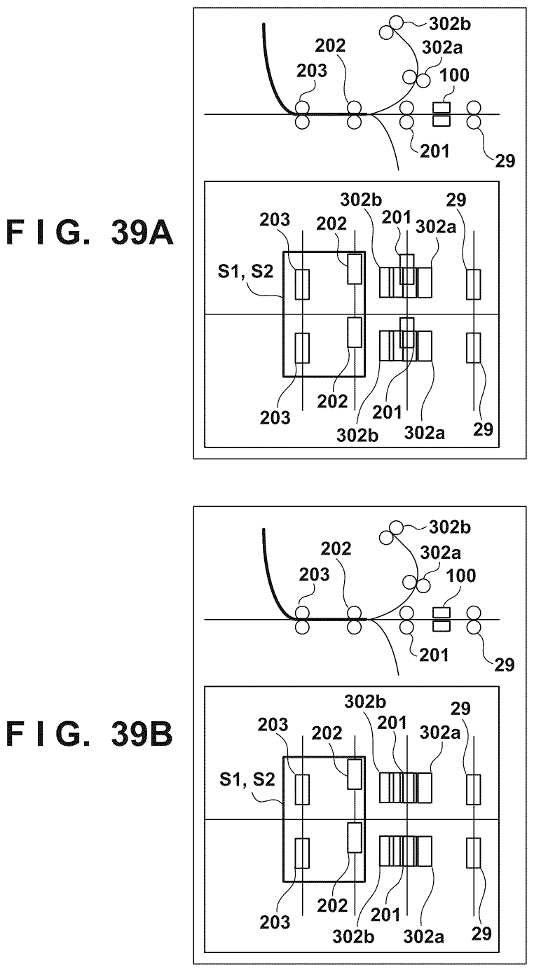

In step S303, the binding processing control unit 95 moves the upper conveyance path flapper 34 to the upper conveyance path guide position. A path to guide the sheet conveyed on the straight path 28 to the upper conveyance path 30 is thus formed. When the trailing edge of a sheet of a small size passes through the shift rollers 202, the leading edge of the sheet is located near the discharge rollers 36. However, when the trailing edge of a sheet of a large size passes through the shift rollers 202, the leading edge of the sheet may protrude outside the apparatus. In this case, the sheet may twist or break. In this embodiment, in the case of a sheet of a large size, the sheet is conveyed on the upper conveyance path 30, as shown in FIGS. 36A to 39B, thereby preventing the above-described twist or breakage of the sheet. Note that the states shown in FIGS. 36A and 36B correspond to the states shown in FIGS. 17A and 17B in the case of a sheet of a small size. The state shown in FIG. 37 corresponds to the state shown in FIG. 18A in the case of a sheet of a small size. The states shown in FIGS. 38A and 38B correspond to the states shown in FIGS. 22A and 22B in the case of a sheet of a small size. The states shown in FIGS. 39A and 39B correspond to the states shown in FIGS. 32A and 32B in the case of a sheet of a small size. Note that in the buffer operation of the sheet of a large size, the detection result of a sensor (not shown) provided in the upper conveyance path 30 may be used to detect the position of the sheet, or the position of the sheet may be detected using the inlet sensor Se1.

In steps S307 and S324, the binding processing control unit 95 separates the intermediate conveyance rollers 203 and the upper conveyance rollers 303. This enables registration adjustment of the sheet of the large size by the shift rollers 201 and 202.

In steps S311 and S331, the binding processing control unit 95 sets the intermediate conveyance rollers 203 and the upper conveyance rollers 303 in the nip state again. This enables conveyance of the sheet of the large size.

The straight path described in this embodiment need not always have a perfect linear shape, and should allow coated paper whose grammage is more than 500 g/m² to be conveyed at 1,750 mm/sec without being damaged. More specifically, the curvature of the path is preferably set to a moderate curvature of not less than 100R (radius of 100 mm). Also, the conveyance roller pairs sometimes protrude from the path surface, and the protrusion amount is preferably about 1 mm to 2 mm from the lower surface of the path. Note that the coated paper whose grammage is more than 500 g/m² is so-called cardboard, and this paper type is used for paper packages, magazine covers, and the like.

As described above, according to this embodiment, it is possible to buffer sheets continuously supplied from the image forming apparatus A, make the sheets overlap, and then send these to a saddle-stitching/folding processing unit.

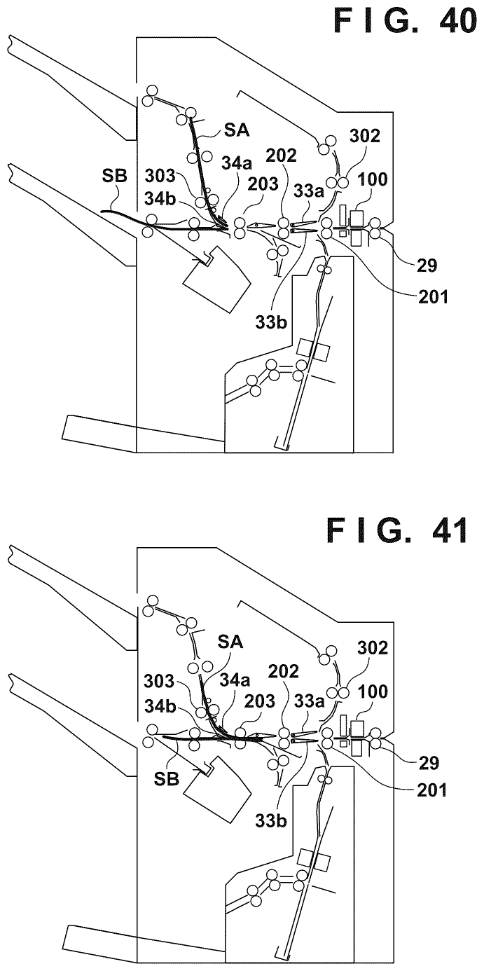

Note that in another embodiment to be described below as well, a sheet t be sent to the saddle unit B2 can be buffered. Another embodiment will be described with reference to FIGS. 40 and 41. FIG. 40 shows a state in which before saddle processing of a preceding sheet bundle is completed, the first sheet (preceding sheet SA) and the second sheet (subsequent sheet SB) of the next sheet bundle are buffered.

The preceding sheet SA is fed to an upper conveyance path 30. When the trailing edge of the preceding sheet retreats from a straight path 28, the sheet is temporarily stopped and made to stay. Next, the subsequent sheet SB is fed toward a straight path discharge port 35. When the trailing edge of the subsequent sheet SB in the conveyance direction passes the branch portion (flappers 34a and 34b of an upper conveyance path flapper 34) to the upper conveyance path 30, the sheet is switchback-conveyed.

When the switchback conveyance of the subsequent sheet SB starts, conveyance of the preceding sheet SA to the straight path 28 also starts. FIG. 41 shows a state in which the subsequent sheet SB and the preceding sheet SA are aligned. After the sheets are aligned, the sheet bundle is supplied to the saddle path 32.

Even in the operation according to the other embodiment described above, saddle buffer can be performed up to two sheets.

According to the present disclosure, it is possible to align a sheet bundle and then feed it to a bookbinding processing path.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A bookbinding processing apparatus comprising:
a conveyance path configured to convey a sheet from a loading port to an unloading port;
a bookbinding processing unit configured to, provided on a lower side of the conveyance path, perform bookbinding processing including binding and folding for a sheet bundle;
a bookbinding processing path configured to convey the sheet from the conveyance path to the bookbinding processing unit;
a conveyance unit configured to, provided in the conveyance path, convey the sheet;
a detection unit configured to detect that the sheet conveyed by the conveyance unit reaches a predetermined position;
a buffer path provided on an upper side of the conveyance path and configured to buffer the sheet;
a buffer conveyance unit configured to, provided in the buffer path, convey the sheet;
a conveyance control unit configured to control the conveyance unit to feed a preceding sheet conveyed through the conveyance path to the buffer path; and
a buffer conveyance control unit configured to control the buffer conveyance unit to convey the preceding sheet from the buffer path to the conveyance path based on a detection result of a subsequent sheet following the preceding sheet by the detection unit,
wherein the conveyance control unit controls the conveyance unit to feed bundle of the preceding sheet and the subsequent sheet to the bookbinding processing path.

2. The bookbinding processing apparatus according to claim 1, wherein
the buffer path is provided such that the preceding sheet is fed while moving in a direction from the unloading port to the loading port,
the bookbinding processing path is provided such that the bundle of the preceding sheet and the subsequent sheet is fed while moving in the direction from the unloading port to the loading port, and
the buffer path and the bookbinding processing path are arranged to at least partially face each other across the conveyance path.

3. The bookbinding processing apparatus according to claim 1, wherein
the conveyance unit comprises a roller pair capable of rotating in forward and reverse directions,
the buffer path is provided such that the preceding sheet conveyed from the loading port to the unloading port is fed by reversely rotating the roller pair,
the bookbinding processing path is provided such that the bundle of the subsequent sheet and the preceding sheet conveyed from the loading port to the unloading port is fed by reversely rotating the roller pair, and
an inlet of the buffer path and the inlet of the bookbinding processing path are arranged on an upstream side of the roller pair in a direction from the loading port to the unloading port.

4. The bookbinding processing apparatus according to claim 2, wherein
the bookbinding processing unit comprises:
a stopper configured to stop a lower end of a sheet bundle fed through the bookbinding processing path; and
a support unit configured to support the sheet bundle stopped by the stopper,
wherein the support unit is arranged such that a lower end of the support unit is arranged on a downstream side with respect to an upper end in the direction from the loading port to the unloading port, and
the buffer conveyance control unit controls the buffer conveyance unit such that when aligning the preceding sheet and the subsequent sheet, a trailing edge of the preceding sheet is located on an upstream side with respect to a trailing edge of the subsequent sheet in the direction from the loading port to the unloading port.

5. The bookbinding processing apparatus according to claim 1, further comprising
position detection unit configured to detect a position of the sheet,
wherein the buffer conveyance control unit controls the buffer conveyance unit based on a detection result by the position detection unit such that buffering is performed at a position where a leading edge of the preceding sheet conveyed to the buffer path is apart from the conveyance path by a predetermined distance.

6. An image forming system comprising:
an image forming unit configured to form an image on a sheet;
a conveyance path configured to convey the sheet with the image formed the image forming unit from the image forming unit to an unloading port;
a bookbinding processing unit configured to, provided on a lower side of the conveyance path, perform bookbinding processing including binding and folding for a sheet bundle;
a bookbinding processing path configured to convey the sheet from the conveyance path to the bookbinding processing unit;
a conveyance unit configured to, provided in the conveyance path, convey the sheet;
a detection unit configured to detect that the sheet conveyed by the conveyance unit reaches a predetermined position;
a buffer path provided on an upper side of the conveyance path and configured to buffer the sheet;
a buffer conveyance unit configured to, provided in the buffer path, convey the sheet;
a conveyance control unit configured to control the conveyance unit to feed a preceding sheet conveyed through the conveyance path to the buffer path; and
a buffer conveyance control unit configured to control the buffer conveyance unit to convey the preceding sheet from the buffer path to the conveyance path based on a detection result of a subsequent sheet following the preceding sheet by the detection unit,
wherein the conveyance control unit controls the conveyance unit to feed bundle of the preceding sheet and the subsequent sheet to the bookbinding processing path.
